(19) United States
(12) Patent Application Publication
(10) Pub. No.: US 2016/0269806 A1
(43) Pub. Date: Sep. 15, 2016

(54) SELECTION METHOD OF RELAYING DEVICE, AND SELECTION PROGRAM OF RELAYING DEVICE

(71) Applicant: FUJITSU LIMITED, Kawasaki-shi (JP)

(72) Inventors: Tetsuya UCHIUMI, Kawasaki (JP); YASUHIDE MATSUMOTO, Kawasaki (JP); Shinji Kikuchi, Yokohama (JP); Shinya Kitajima, Shinagawa (JP)

(73) Assignee: FUJITSU LIMITED, Kawasaki-shi (JP)

(21) Appl. No.: 15/063,589

(22) Filed: Mar. 8, 2016

(30) Foreign Application Priority Data
Mar. 13, 2015 (JP) 2015-050151

(51) Int. Cl. H04Q 9/00; H04B 7/15

(52) U.S. Cl. CPC H04Q 9/00; H04B 7/15

(57) ABSTRACT

A selection method of a relaying device includes collecting, by a processing unit, sensor data which a sensor in a device detects from one or a plurality of the device; and selecting, by the processing unit, when changing relaying device which process a certain sensor from one relaying device to another relaying device among a plurality of the relaying devices which carries out the one or more processing prescribed depending on the sensor and outputs a result of the processing in each, a relaying device that a number of processing, which is not included in a set of a plurality of the processing of sensors that the relaying device targets among a plurality of the processing prescribed depending on the certain sensor, is less, as a candidate of another relaying device.

### CROSS-REFERENCE TO RELATED APPLICATION

This application is based upon and claims the benefit of priority of the prior Japanese Patent Application No. 2015-050151, filed on Mar. 13, 2015, the entire contents of which are incorporated herein by reference.

### FIELD

The embodiments discussed herein are related to a selection method of relaying device, and selection program of relaying device.

### BACKGROUND

There is information processing system which collect the data that each of a plurality of devices with a sensor acquired via a relaying device and carry out a appointed processing based on the collected data. The information processing system has the plurality of devices such as handheld terminals, a plurality of the relaying devices and an information processing device.

The device sends sensor data of which the sensor detected to the relaying device and the relaying device carries out the processing corresponding to the sensor for the sensor data which is received and sends a processing result to the information processing device. The relaying device is equipped with application program to carry out the processing corresponding to a type of the sensor to be targeted for the collection of sensor data.

Patent documents 1 and 2 disclose the technique in conjunction with the processing of sensor network system. In addition, the patent document 3 discloses the communication of the computer carrying out a virtual machine and the patent document 4 discloses system that the devices with the different function are mixed.

### CITATION LIST

### Patent Document

[Patent document 1] Japanese National Publication of International Patent Application No. 2010-527473.

[Patent document 2] Japanese Laid-Open Patent Publication No. 2006-344017.

[Patent document 3] Japanese National Publication of International Patent Application No. 2009-545244.

[Patent document 4] Japanese Laid-Open Patent Publication No. 2005-135212.

However, a diversification of the devices advances according to development of IoT (Internet of Things), and the information processing system comes to collect the sensor data of various types of sensors. In addition, versions or vendors of the sensor may be different even if the kind is the same sensor.

The content of the processing that the relaying device performs for the sensor data is different depending on the kind and the version, the vendor of the sensor. When collecting the sensor data of plural different sensors, the relaying device is equipped with a plurality of application programs to carry out the processing corresponding to each sensor. Therefore, the number of applications that the relaying device is equipped increases depending on a sensor for the collection, and the resource quantity that application uses may grow big.

On the other hand, the relaying device may newly collect the sensor data of the device concerned depending on the movement of the device. When the relaying device is not equipped with the application to carry out the processing corresponding to a sensor of the device, the relaying device is equipped with the newly application program concerned. Therefore, it is desirable for the relaying device to have a space resource for deployment of the new application program.

### SUMMARY

According to an aspect of the embodiments, a selection method of a relaying device includes, collecting, by a processing unit, sensor data which a sensor in a device detects from one or a plurality of the device; and selecting, by the processing unit, when changing relaying device which process a certain sensor from one relaying device to another relaying device among a plurality of the relaying devices which carries out the one or more processing prescribed depending on the sensor and outputs a result of the processing in each, a relaying device that a number of processing, which is not included in a set of a plurality of the processing of sensors that the relaying device targets among a plurality of the processing prescribed depending on the certain sensor, is less, as a candidate of another relaying device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining constitution of information processing system 100 according to the embodiment.

FIG. 2 is a diagram indicating an example of the sensor according to the embodiment.

FIG. 3 is a diagram indicating a first selection example of the relaying device 20 which collects the sensor data of each sensor.

FIG. 4 is a diagram indicating a second selection example of the relaying device 20 which collects the sensor data of each sensor.

FIG. 5 is a diagram indicating the selection example of the relaying device 20 for the device 30 which moved according to the embodiment.

FIG. 6 is a diagram explaining constitution of the information processing system 100 when realizing the relaying device 20 according to the virtual machine.

FIG. 7 is a diagram of hardware constitution of the center server 10 in FIG. 1, FIG. 6.

FIG. 8 is a diagram explaining an example of the sensor information list 111 which is illustrated in FIG. 7.

FIG. 9 is a diagram explaining an example of the application information list 112 depicted in FIG. 7.

FIG. 10 is a diagram explaining an example of relaying device information list 113 depicted in FIG. 7.

FIG. 11 is a software block diagram of virtual machine deployment program 110 in the center server 10 depicted in FIG. 7.

FIG. 12 is a diagram of hardware constitution of physical machine 40 having the relaying device 20 depicted by FIG. 6.

FIG. 13 is a software block diagram of virtual machine No.1 data 231 depicted by FIG. 12.

FIG. 14 is a diagram of the hardware constitution of the device 30 depicted by FIG. 1 and FIG. 6.

FIG. 15 is a software block diagram of the device 30 depicted by FIG. 1 and FIG. 6.

FIG. 16 is a diagram of flow chart explaining the processing of the virtual machine deployment program 110 in the center server 10 depicted in FIG. 11.

FIG. 17 is a diagram of first flow chart explaining a flow of processing No. 1 of the deployment order making module 123 (S11 of FIG. 16) depicted in FIG. 11.

FIG. 18 is a diagram explaining the process S22, S23 of FIG. 17.

FIG. 19 is a diagram of second flow chart explaining a flow of the processing No. 1 of deployment order making module 123 (S11 of FIG. 16) depicted in FIG. 11.

FIG. 20 is a diagram of third flow chart explaining a flow of processing No. 1 of deployment order making module 123 (S11 of FIG. 16) depicted in FIG. 11.

FIG. 21 is a diagram of first flow chart explaining a flow of processing No. 2 of the deployment order making module 123 (S13 of FIG. 16, S44 of FIG. 20) depicted in FIG. 11.

FIG. 22 is a diagram indicating the sensor that the device 2-4 in the present embodiment targets for the processing.

FIG. 23 is a diagram of second flow chart explaining a flow of the processing No. 2 of the deployment order making module 123 (S13 of FIG. 16, S44 of FIG. 20) depicted in FIG. 11.

FIG. 24 is a diagram of third flow chart explaining a flow of processing No. 2 of the deployment order making module 123 depicted in FIG. 11 (S13 of FIG. 16, S44 of FIG. 20).

FIG. 25 is a diagram of flow chart explaining a flow of processing No. 3 of the deployment order making module 123 (S16 of FIG. 16) depicted in FIG. 11.

### DESCRIPTION OF EMBODIMENTS

Hereinafter, embodiments will be described according to figures. But the technical range in the invention are not limited to the embodiments, are extended the subject matters disclosed in claims and its equivalents.

[Information Processing System]

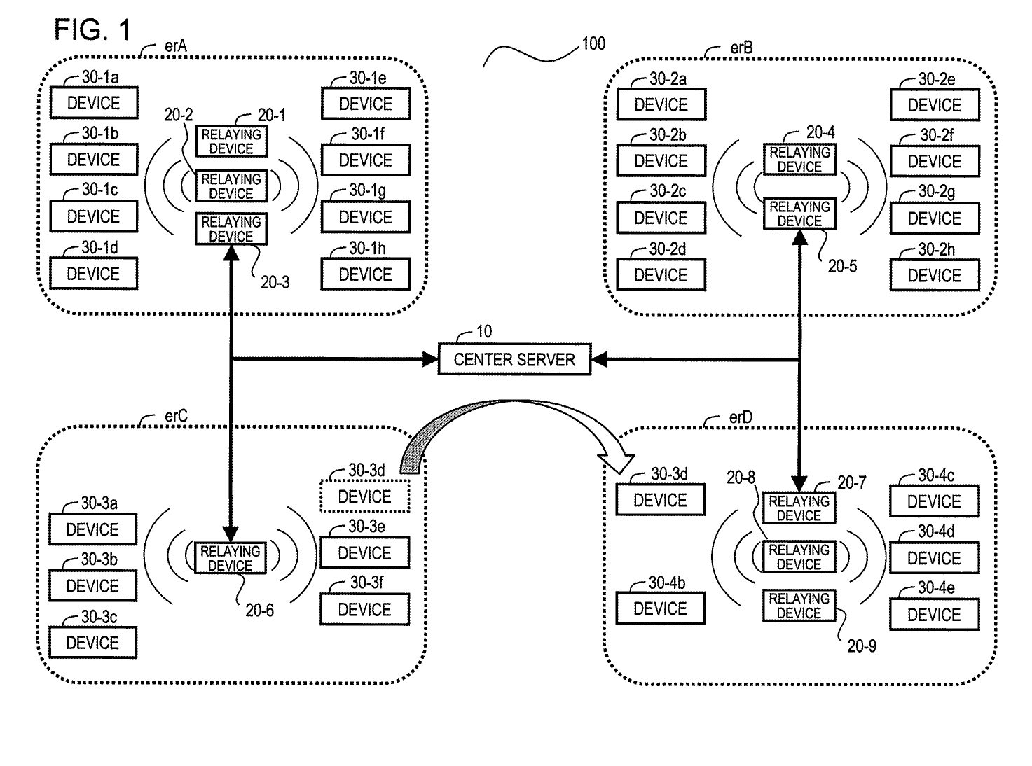

FIG. 1 is a diagram explaining constitution of information processing system 100 according to the embodiment. The information processing system 100 in FIG. 1 has a central server (information processing device) 10, a plurality of relaying devices 20-1-20-9 (also called as relaying device 20) and a plurality of devices 30-1a-30-4e (also called as apparatus, or device 30). In really, the information processing system 100 has a large number of devices 30.

Each of the devices 30 connect to the relaying device 20 through the wireless communication based on standards such as LTE (Long Term Evolution) or Bluetooth (registered trademark). In addition, the relaying device 20 connects to the center server 10 through a wire cable communication, for example. In addition, the relaying device 20 may connect to the center server 10 through the wireless communication.

According to the example of FIG. 1, the devices 30-1a-30-1h, which are located in domain erA, position in an appointed distance range from the relaying device 20-1-20-3 and are able to communicate with the relaying device 20-1-20-3. Similarly, the devices 30-2a-30-2h which are located in domain erB, position in an appointed distance range from the relaying device 20-4, 20-5 and are able to communicate with the relaying device 20-4, 20-5. It is similar about device 30 and relaying device 20 which are located in other domains erC, erD.

The device 30 depicted in FIG. 1 is an apparatus such as a smart-phone, a wearable device, and a mobile music device. Each of the devices 30 is equipped with one or more sensors. In addition, the device 30 is equipped with a same or different sensor each other. The sensor, for example, is a temperature sensor, a humidity sensor, an acceleration sensor, a living body sensor, and a position sensor, etc. In this embodiment, the device 30 includes a movable device 30. In addition, the device 30 may include a device 30 located fixedly in the place to sense.

Each device 30 regularly acquires the sensor data of which the sensor detected, and sends the sensor data which is acquired to the relaying device 20. The sensor data is temperature data, acceleration data, heart rate data, blood pressure data, position data, for example. In addition, the device 30 may send sensor data to the relaying device 20 in response to the acquisition instruction of sensor data from the relaying device 20 or the center server 10.

The center server 10 depicted in FIG. 1 carries out the analysis processing of sensor data of each device 30 which is collected through the relaying device 20. In addition, the relaying device 20 depicted in FIG. 1 relays communication with one or more device 30 and the center server 10. The relaying device 20 collects sensor data from one or more device 30 and carries out single or plural processing prescribed depending on the sensor which each device 30 is equipped with for the sensor data and outputs the processing result to the center server 10. The relaying device 20 is equipped with application program to carry out the processing prescribed depending on a target sensor which collects sensor data.

The processing prescribed depending on a sensor is a processing by the function that the OS (Operating System) and software include or a processing which is inherent to the sensor data, for example. The processing by the functions that the OS and software include is write processing of data to a database or copy process of the data, for example. In addition, the processing which is inherent to the sensor data is a conversion processing of form that is inherent to the sensor data or the count processing that is inherent to the sensor data, for example.

The information processing system 100 depicted in FIG. 1 is a system which analyzes living body information and environmental information of the user in medical facilities or welfare institution. The relaying device 20 collects the temperature data or the heart rate data from the smart-phone or the wearable device which equip with a temperature sensor or a living body sensor, and carries out the conversion processing of the data and the storage processing of the data to the database. And the relaying device 20 reads data after the processing from the database, and transmits it to the center server 10. The center server 10 carries out monitoring processing or count processing of health condition of the user based on the sensor data which is collected.

In addition, the content of the processing of which the relaying device 20 carries out for the sensor data is different depending on the kind of the sensor. And the versions of the sensor or vendors (company) providing the sensor may be different even if kind of the sensors are same. Therefore, the contents of the processing of which the relaying device 20 carries out for the sensor data is different depending on the version or the vendor which provides the sensor in addition to the kind of the sensor.

The information processing system 100 depicted in FIG. 1 includes a dedicated relaying device 20 depending on the kind, the vendor, and the version of the sensor, for example. In other words, single relaying device 20 collects only the sensor data of the specific sensor. When each relaying device 20 collects only the sensor data of the specific sensor, the relaying device 20 concerned may be equipped only with the application program to carry out the processing prescribed depending on the specific sensor.

However, when a variety of sensors is provided, it is necessary to prepare large number of relaying devices 20, thereby many resources is needed. In addition, when large number of devices 30 equipped with a specific sensor exists, it may occur that the number of devices 30 which the relaying device 20 connects may exceed connectable numbers or the data quantity of which relaying device 20 processes is more than a tolerable amount. Therefore, a case that it is difficult that the relaying device 20 processes the sensor data may occur.

Or, the information processing system 100 has a relaying device 20 for general purpose which collects the sensor data from a variety of sensors. In other words, single relaying device 20 collects the sensor data of plural different sensors. When the relaying device 20 collects the sensor data of plural different sensors, the relaying device 20 concerned is equipped with application programs to carry out the processing of corresponding sensor data depending on plural sensors.

When the information processing system 100 has the relaying device 20 for general purpose, the center server 10 selects the relaying device 20 which collects the sensor data of each device 30 based on electric wave environment, etc. According to the example of FIG. 1, the center server 10 selects the relaying device 20 which collects the sensor data of each sensor of which each device 30-1a-30-1h are equipped with, among the relaying devices 20-1-20-3. It is similar about the devices 30-2a-30-4e which are located in other domain erB-erD.

The center server 10 selects the relaying device 20 in which electric wave environment has good among a plurality of devices 20 which are located in an appointed distance range from the device 30, as a relaying device 20 which collects the sensor data of the device 30. Therefore, depending on the selection of the relaying device 20, a redundant degree of the same processing between the plurality of relaying devices 20 may become higher. When the redundant degree of the processing is high, large number of same applications operates on the plurality of relaying devices 20 and it indicates that a resource of the relaying device 20 is not available effectively.

The device 30 according to the embodiment includes a movable device 30 as mentioned above. When the device 30-3d moves to domain erD from domain erC as depicted in FIG. 1, the center server 10 selects the relaying device 20 which collects the sensor data of the sensor equipped with the device 30-3d among the relaying devices 20-7-20-9. And when selected relaying device 20 is not equipped with application program to process the sensor data of the device 30-3d, the relaying device 20 is equipped with application newly.

When the selected relaying device 20 does not have a resource required for the equipment of the new application program, it is not possible that the relaying device 20 installs the application program and collects the sensor data of the device 30-3d. Therefore, it is not possible that the center server 10 collects the sensor data of each device 30 precisely. Therefore, it is desirable that each relaying device 20 has a space resource in preparation for movement of the device 30. In other words, it is desirable that the quantity of the resource that the application program uses is held down by using a resource of the relaying device 20 effectively.

### First Summary of Embodiment

Therefore, the center server 10 according to the embodiment, when selecting the relaying device 20 which processes the sensor data of each sensor among the plurality of relaying devices 20, selects the relaying device 20 based on the processing prescribed depending on the sensor which is a collection target of each relaying device 20. In other words, the center server 10 selects the relaying device 20 of each sensor, which has fewer total numbers of the processing prescribed depending on the sensor which is a processing target of the relaying device 20 in the plurality of relaying devices 20, as a candidate.

In other words, the center server 10 according to the embodiment, when selecting the relaying device 20 processing the sensor data of each sensor, selects the relaying device 20 of each sensor so as to raise a collection degree of the application program between the plurality of relaying devices 20. Therefore, it is possible to reduce the total number of application programs, which is installed on the relaying devices 20 in the information processing system 100 and to use a resource of relaying devices 20 effectively.

In addition, it is possible that the center server 10 increases a space resource of the relaying device 20 in preparation for the equipment of the new application program, by holding down the total number of application programs. Thereby, it is possible that the relaying device equips of new application program, and the center server 10 becomes to collect the sensor data of each sensor more surely. In addition, it is possible to restrain the expansion of the relaying device 20, and outbreak such as an obstacle or the maintenance of the relaying device 20, depending on the lack of the resource of relaying device 20.

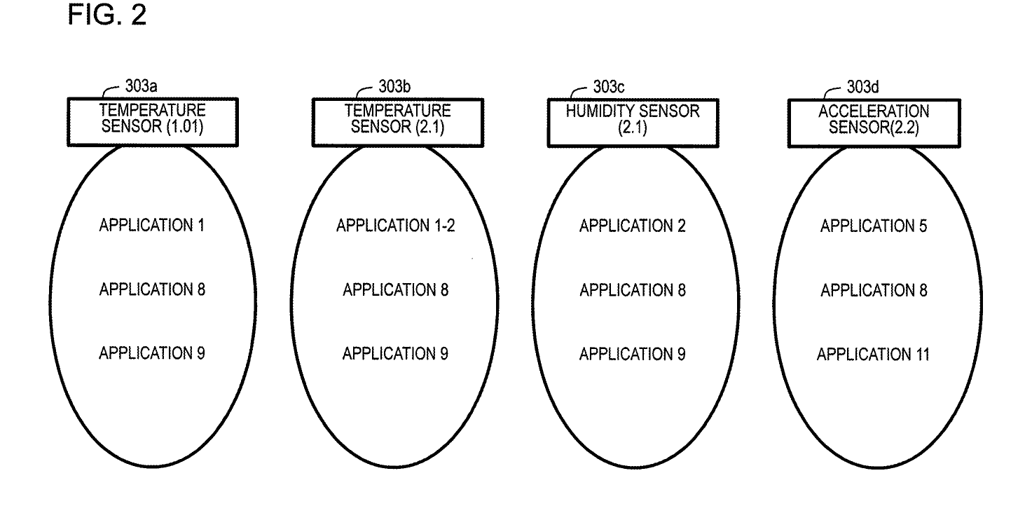

FIG. 2 is a diagram indicating an example of the sensor according to the embodiment. FIG. 2 exemplifies four sensors 303a-303d. A first device 30 (not illustrate in FIG. 2) is equipped with a temperature sensor (1.01) 303a, and a second device 30 (not illustrated in FIG. 2) is equipped with a temperature sensor (2.1) 303b. In addition, a third device 30 (not illustrated in FIG. 2) is equipped with a humidity sensor (2.1) 303c, and a fourth device 30 (not illustrated in FIG. 2) is equipped with an acceleration sensor (2.2) 303d.

The temperature sensor (1.01) 303a is a temperature sensor of version “1.01”. The temperature sensor (2.1) 303b is a temperature sensor of version “2.1”. In other words, it is indicated that the temperature sensor (1.01) 303a and the temperature sensor (2.1) 303b are the sensor of the same kind, but of different version each other. In addition, the humidity sensor (2.1) 303c is a humidity sensor of version “2.1”, and the acceleration sensor (2.2) 303d is an acceleration sensor of version “2.2”.

As described in FIG. 2, the application program which carries out the processing prescribed depending on the temperature sensor (1.01) 303a, is applications 1, 8 and 9. Similarly, the application program which carries out the processing prescribed depending on the temperature sensor (2.1) 303b, is applications 1-2, 8 and 9. Furthermore, the application program which carries out the processing prescribed depending on the humidity sensor (2.1) 303c, is applications 2, 8 and 9, and the application program which carries out the processing prescribed depending on the acceleration sensor (2.2) 303d, is applications 5, 8, 11.

Between the sensors 303a-303d depicted in the example of FIG. 2, the application 8 is common among the applications to carry out the processing prescribed depending on each sensor. For example, the processing that the application 8 carries out is the storage processing of the sensor data to a database. In addition, between the temperature sensor (1.01) 303a and the temperature sensor (2.1) 303b, the application 9 is common. The processing that the application 9 carries out is the conversion processing of format of the sensor data of the temperature sensor, for example. In addition, the processing of the applications 1, 1-2 is a processing of the sensor data of the temperature sensor which is different from each other depending on the version.

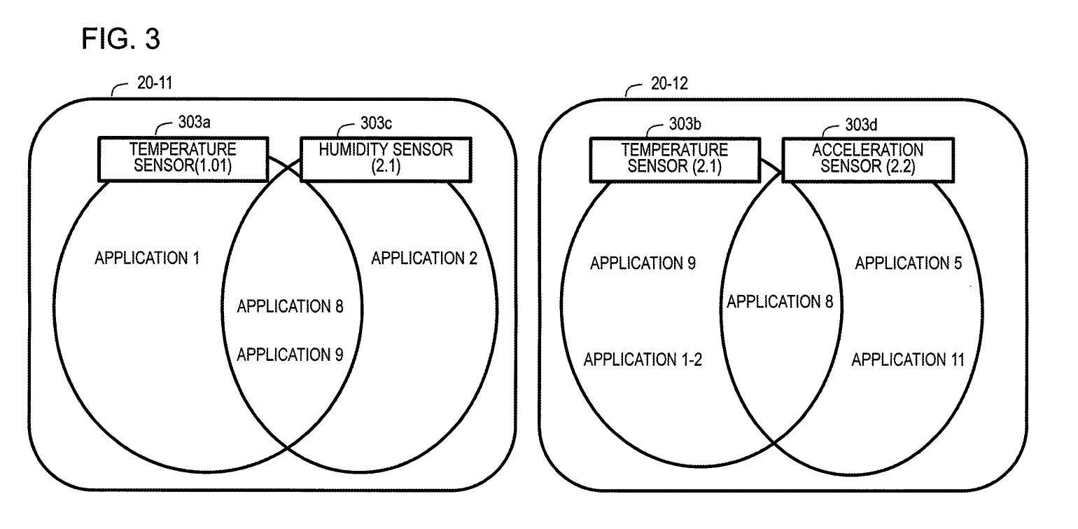

FIG. 3 is a diagram indicating a first selection example of the relaying device 20 which collects the sensor data of each sensor. The center server 10 selects the relaying device 20, which collects each sensor data of the temperature sensor (1.01) 303a, the temperature sensor (2.1) 303b, the humidity sensor (2.1) 303c, and the acceleration sensor (2.2) 303d, among the first and second relaying devices 20-11, 20-12.

According to the first selection example depicted in FIG. 3, the first relaying device 20-11 collects the sensor data of the temperature sensor (1.01) 303a and the humidity sensor (2.1) 303c. In addition, the second relaying device 20-12 collects the sensor data of the temperature sensor (2.1) 303b and the acceleration sensor (2.2) 303d. The processing of the temperature sensor (1.01) 303a and the humidity sensor 303c include the application 8 and 9 in common. In addition, the processing of the temperature sensor (2.1) 303b and the acceleration sensor (2.2) 303d include the application 8 in common.

Therefore, the first relaying device 20-11 carries out four applications 1, 2, 8 and 9, and the second relaying device 20-12 carries out five applications 1-2, 5, 8, 9 and 11. According to the first selection example, the total of the number of processing that the first and second relaying device 20-11, 20-12 carry out is value “9” (=4+5).

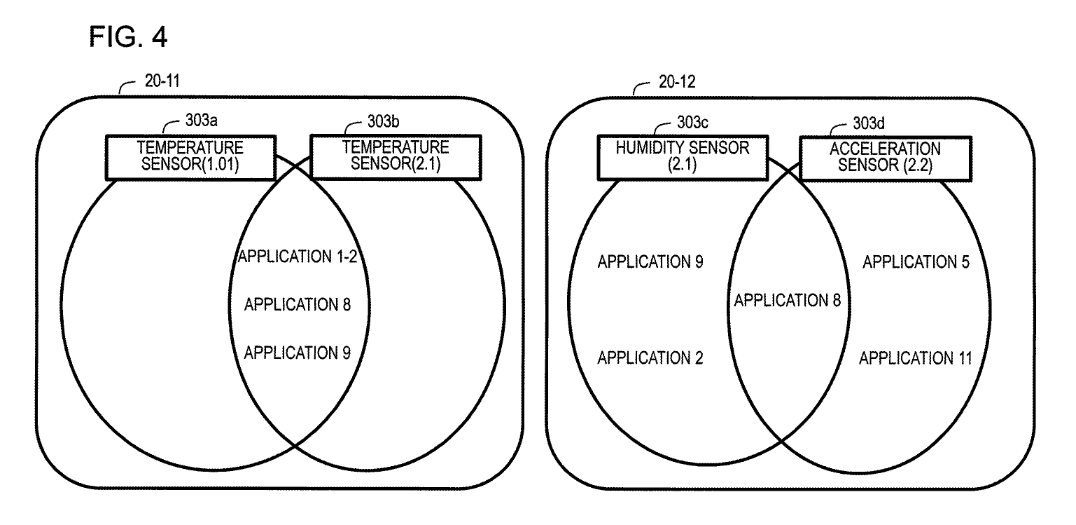

FIG. 4 is a diagram indicating a second selection example of the relaying device 20 which collects the sensor data of each sensor. In FIG. 4, same elements are represented in the same sign depicted in FIG. 3.

According to the second selection example depicted in FIG. 4, the first relaying device 20-11 collects the sensor data of the temperature sensor 303a (1.01) and the temperature sensor 303b (2.1). In addition, the second relaying device 20-12 collects the sensor data of the humidity sensor 303c (2.1) and the acceleration sensor 303d (2.2).

In this embodiment, the applications 1-2 include a function of the application 1. In other words, the applications 1-2 are executable to the processing of the application 1. Therefore, the processing of the temperature sensor 303a (1.01) and the temperature sensor 303b (2.1) include the applications 1-2 (including the application 1), 8 and 9, in common. In addition, the processing of the humidity sensor 303c (2.1) and the acceleration sensor 303d (2.2) include the application 8 in common.

Therefore, the first relaying device 20-11 carries out three applications 1-2, 8 and 9, and the second relaying device 20-12 carries out five applications 2, 5, 8, 9 and 11. According to the second selection example, the total number of the processing that the first and second relaying devices 20-11, 20-12 carry out is value “8” (=3+5).

The center server 10 according to the embodiment selects a combination of the sensor and the relaying device 20 which has fewer total numbers of applications executed by each relaying device among the first and second relaying devices 20-11, 20-2. Therefore, the center server 10 selects the second selection example which has fewer total number of the applications depicted by FIG. 4. Because the total number of the application programs which are executed by the relaying device 20 is held down in a fewer number, an integration degree of the application is high and a resource of the relaying device 20 is used effectively. In this way, it is possible that the center server 10 selects the relaying device 20 of each sensor so as to use the resource of the relaying device 20 effectively.

### Second Summary of the Embodiment

In addition, when the movement of the device 30 occurs, the center server 10 again selects the relaying device 20 which collects the sensor data of the device 30 which moved. The center server 10 according to the embodiment, based on one or plural processing prescribed depending on the sensor of the device 30 which moved and the processing prescribed depending on each sensor which is a processing object of each relaying device 20, selects a candidate of the relaying device 20. In other words, the center server 10 selects the relaying device 20 that the number of the processing, which is not included in a set of a plurality of the processing of sensors that the relaying device 20 targets among a plurality of the processing prescribed depending on a sensor of the device 30 which moved and, is less, as a candidate of relaying device 20 of the sensor.

In other words, the center server 10 according to the present embodiment selects the relaying device 20, which carries out the processing of the sensor data of the sensor equipped with the device 30 which moved, so that an integration degree of the application becomes high between the plurality of relaying devices 20. Therefore, because the total number of applications equipped on the relaying device 20 in the information processing system 100 decreases, it is possible to use a resource of the relaying device 20 effectively. Accordingly, it is possible that the center server 10 collects the sensor data of each sensor surely, and restrains the expansion, outbreak such as an obstacle or the maintenance of the relaying device 20.

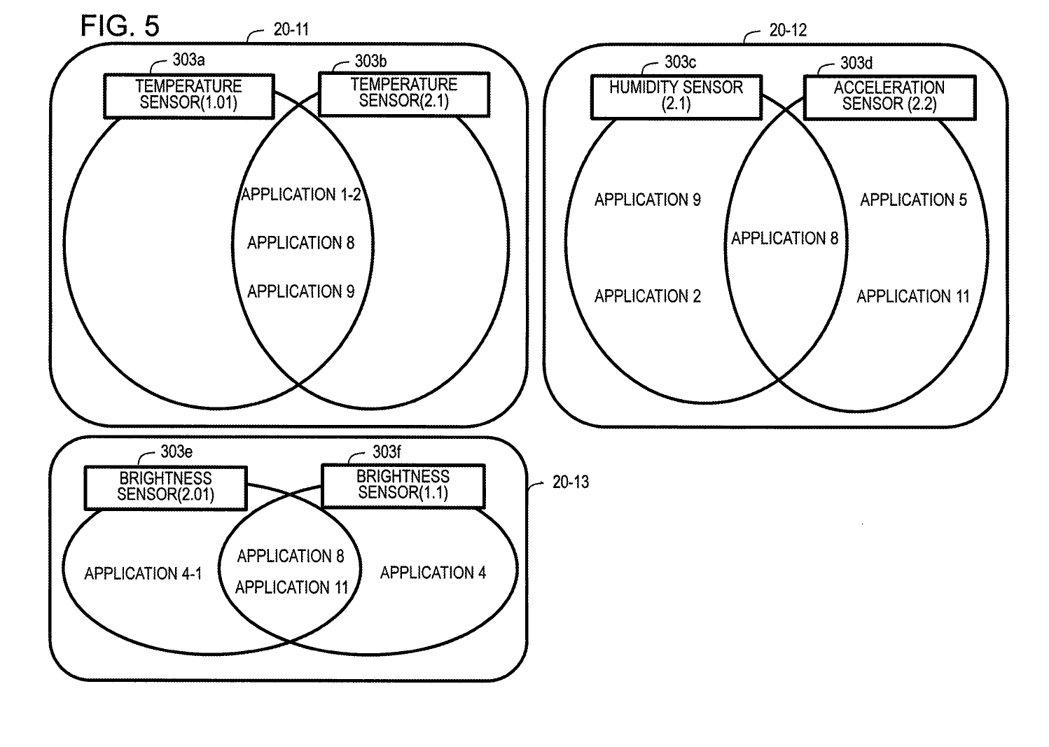

FIG. 5 is a diagram indicating the selection example of the relaying device 20 for the device 30 which moved according to the embodiment. In FIG. 5, same elements are indicated by same signs represented in FIG. 3 and FIG. 4. In FIG. 5, the selection example of the relaying devices 20-11, 20-12, which carry out the processing of sensor data of each sensor 303a-303d, is the same as the second selection example depicted by FIG. 4.

FIG. 5 exemplifies a case that the device 30, which equipped with a brightness sensor 303f (1.1) where the third relaying device 20-13 collected the sensor data, moved to neighborhood of the first, second relaying devices 20-11, 20-12 from the neighborhood of the third relaying device 20-13. The center server 10 selects the relaying device 20 collecting the sensor data of the brightness sensor 303f (1.1) among the first and second relaying device 20-11, 20-12.

As described above in FIG. 4, the first relaying device 20-11 carries out the applications 1-2, 8 and 9, and the second relaying device 20-12 carries out the applications 2, 5, 8, 9, 11. On the other hand, the application, which carry out the processing prescribed depending on the brightness sensor 303f (1.1), is the application 4, 8, 11.

The first relaying device 20-11 does not carry out the applications 4, 11 among the applications 4, 8 and 11 which carry out the processing prescribed depending on the brightness sensor 303f (1.1). In other words, among the applications 4, 8, 11, the number of the applications which are not included in the applications 1-2, 8, 9, which carry out the processing prescribed depending on the sensor that the first relaying device 20-11 targets for processing, are two.

In addition, the second relaying device 20-12 does not carry out the application 4 among the applications 4, 8, 11. In other words, among the applications 4, 8, 11, the number of the applications which are not included in the applications 2, 5, 8, 9, 11 which carry out the processing prescribed depending on the sensor that the second relaying device 20-12 targets for processing, is one.

Therefore, the center server 10 selects the second relaying device 20-12 that there are fewer numbers of the application, which is not included in the application that own relaying device 20 carries out, among the applications 4, 8, 11. In other words, the center server 10 selects the second relaying device 20-12, that application to carry out includes more number of the applications 4, 8, 11, as the relaying device 20 of the sensor which moved among the plurality of relaying devices 20. The second relaying device 20-12 is equipped with the application 4 additionally.

That a number of the applications, which is not included in the application that the own relaying device 20 carries out, is fewer, indicates to suppress the number of applications to install for the processing of the sensor which moved newly, in a few number. That is, this indicates that an integration degree of the application is high, and a resource of relaying device 20 is used effectively. In this way, it is possible that the center server 10 selects the relaying device 20 of the sensor which moved, so as to use a resource of relaying device 20 effectively.

In addition, the relaying device 20 which is explained in FIG. 1-FIG. 5 may be realized according to which of a physical machine or a virtual machine.

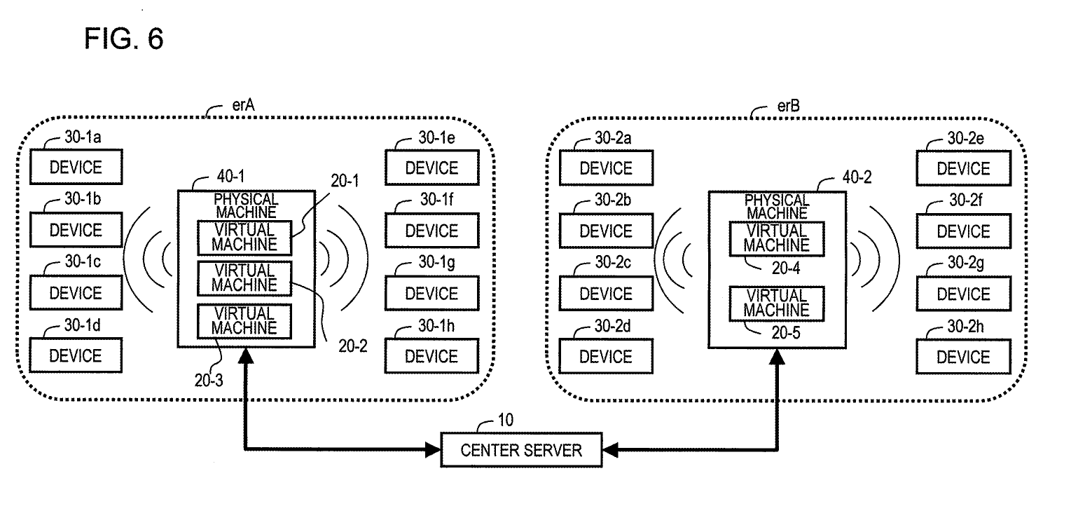

FIG. 6 is a diagram explaining constitution of the information processing system 100 when realizing the relaying device 20 according to the virtual machine. In FIG. 6, same elements as represented by FIG. 1 are same signs in FIG. 1. In FIG. 6, illustrations of the domains erC, erD depicted in FIG. 1 are omitted.

In FIG. 6, physical machines 40-1, 40-2 (also called as physical machine 40) have virtual machines 20-1-20-5 indicating the relaying device 20 each. According to the example of FIG. 6, the physical machine 40-1 carries out three virtual machines 20-1-20-3, and the physical machine 40-2 carries out two virtual machines 20-4, 20-5.

In the example of FIG. 6, the center server 10 selects the relaying device 20, which collects the sensor data of the sensor equipped with the devices 30-1a-30-1h to be located in the domain erA, among the virtual machines 20-1-20-3. Similarly, the center server 10 selects the relaying device 20, which collects the sensor data of the sensor equipped with the devices 30-2a-20-2h to be located in the domain erB, among the virtual machines 20-4, 20-5.

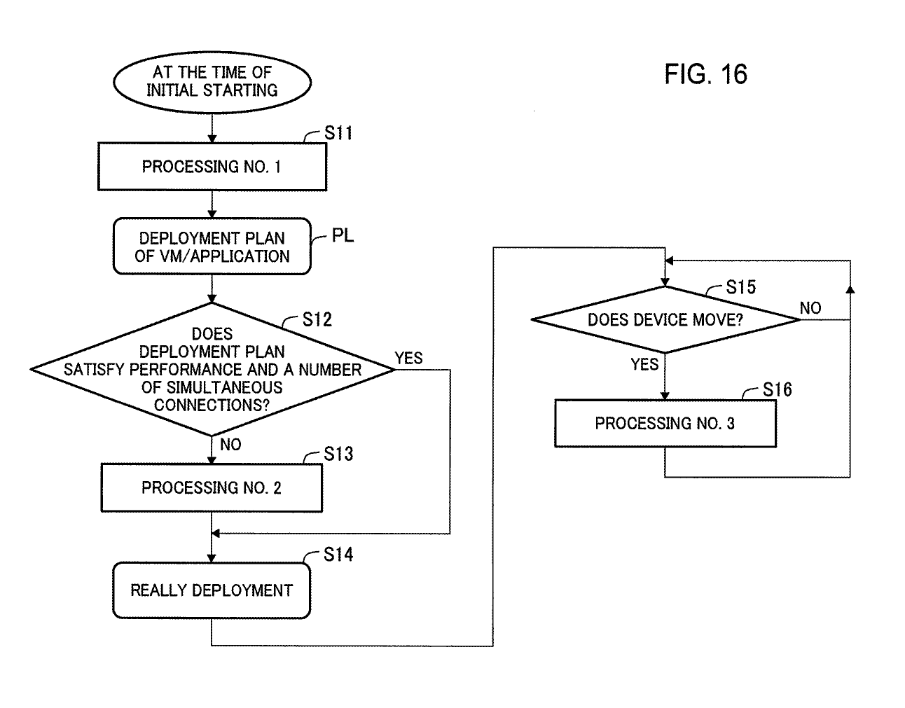

In addition, when realizing the relaying device 20 according to the virtual machine, the center server 10 may set a number of virtual machines 20-1-20-5 which deploy in each physical machines 40-1, 40-2 based on the processing prescribed depending on the sensor for the processing. It is possible that the center server 10 sets the number of virtual machines in most suitable value based on the processing prescribed depending on the sensor for the processing by realizing the relaying device 20 according to a virtual machine. Therefore, it is possible to use a resource of physics machine 40 more effectively. The details will be described later according to a flow chart diagram in FIG. 16.

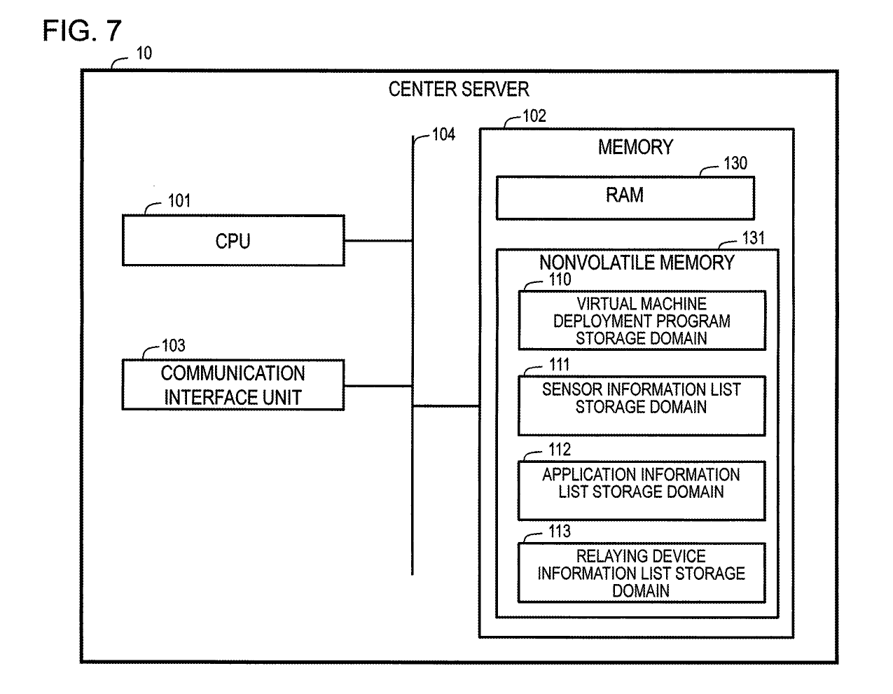

Then, according to FIG. 7-FIG. 11, hardware constitution and software block of the center server, which are represented by FIG. 1, FIG. 6, will be described. In addition, a case to realize the relaying device 20 according to the virtual machine is exemplified in the embodiment.

[Hardware Constitution of Central Server]

FIG. 7 is a diagram of hardware constitution of the center server 10 in FIG. 1, FIG. 6. In FIG. 7, the center server 10 has a CPU 101, a memory 102, a communication interface unit 103, for example. The all parts are connected through a bus 104 mutually. The memory 102 includes a RAM (Random Access Memory) 130 and a nonvolatile memory 131, etc.

The CPU 101 is connected to the memory 102 through the bus 104 and controls whole of the central server 10. The communication interface unit 103 performs transmission and reception of data to the relaying device 20 or other devices (not illustrated in FIG. 7) according to cable communication or wireless communication. The RAM 130 in the memory 102 memorizes the data of which the CPU 101 processes.

The nonvolatile memory 131 in the memory 102 includes a domain (not illustrated in FIG. 7) which stores the program of the OS (Operating System) that the CPU 101 carries out. In addition, the nonvolatile memory 131 includes virtual machine deployment program storage domain 110, sensor information list storage domain 111, application information list storage domain 112, and relaying device information list storage domain 113. The nonvolatile memory 131 is a nonvolatile semiconductor memory, for example.

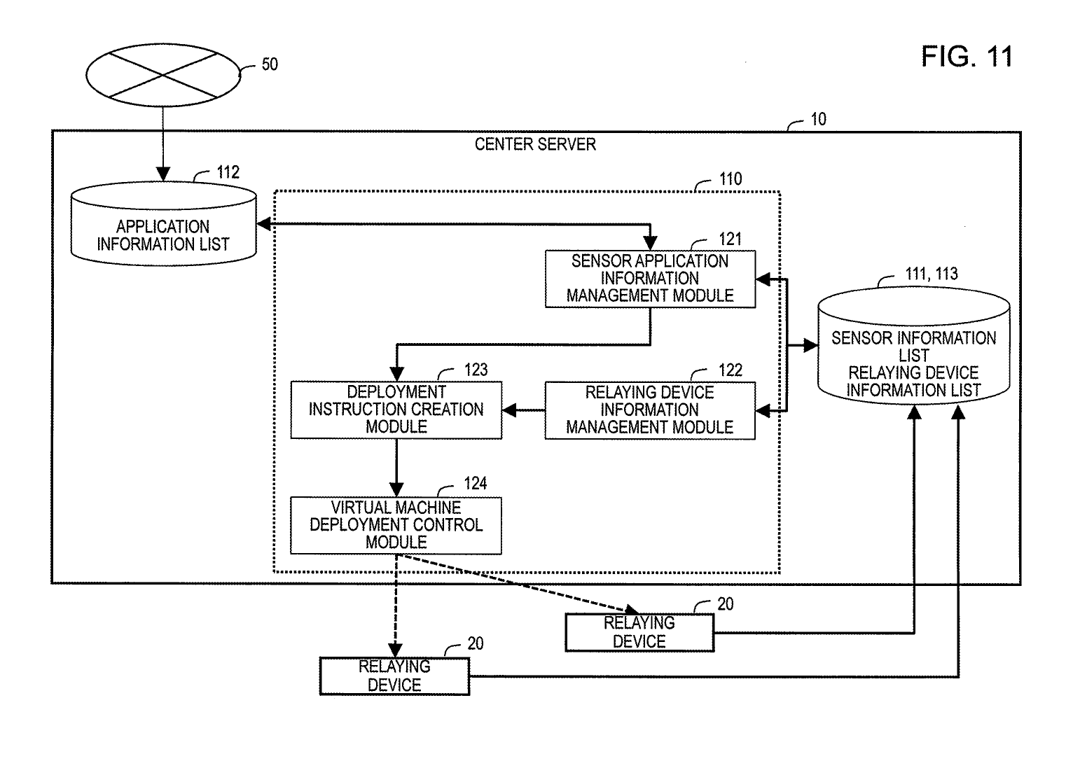

The virtual machine deployment program (below called as virtual machine deployment program 110) in the virtual machine deployment program storage domain 110 carries out creation processing of deployment plan of the virtual machine by execution of the CPU 101. In addition, the virtual machine deployment program 110 instructs the deployment of the virtual machine according to the deployment plan which is created. The details of the processing of virtual machine deployment program 110 will be described later according to FIG. 11.

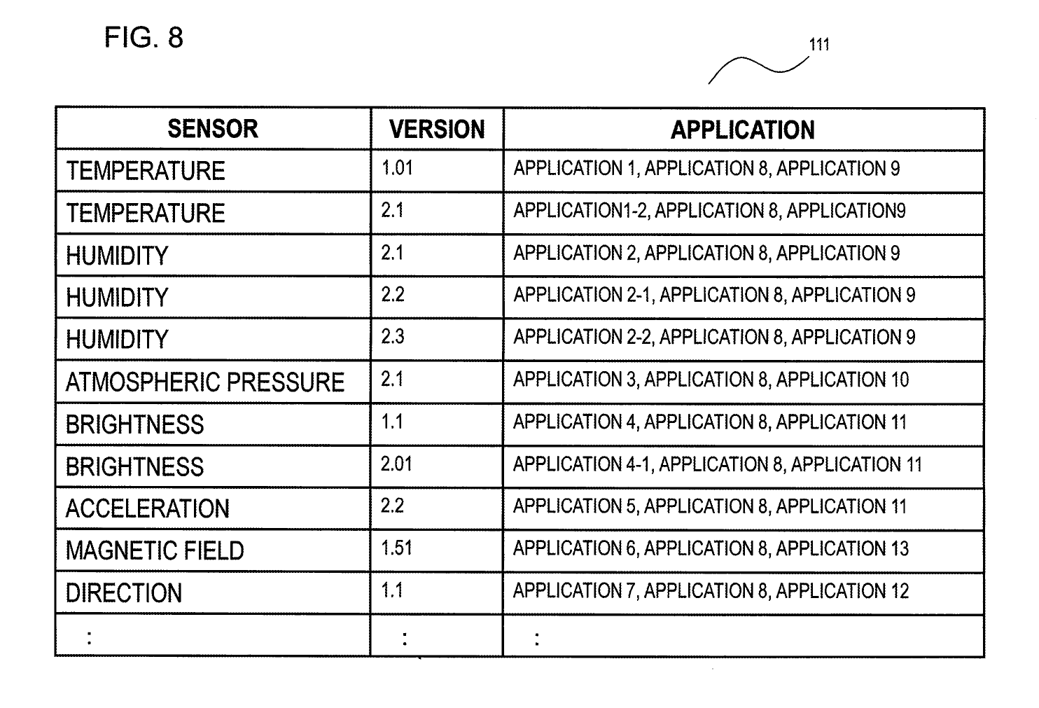

The sensor information list (below, called as sensor information list 111) in the sensor information list storage domain 111 has the information of the target sensor of which the center server 10 collects sensor data. The sensor information list 111 is a database, for example. More details about the sensor information list 111 will be described later according to FIG. 8.

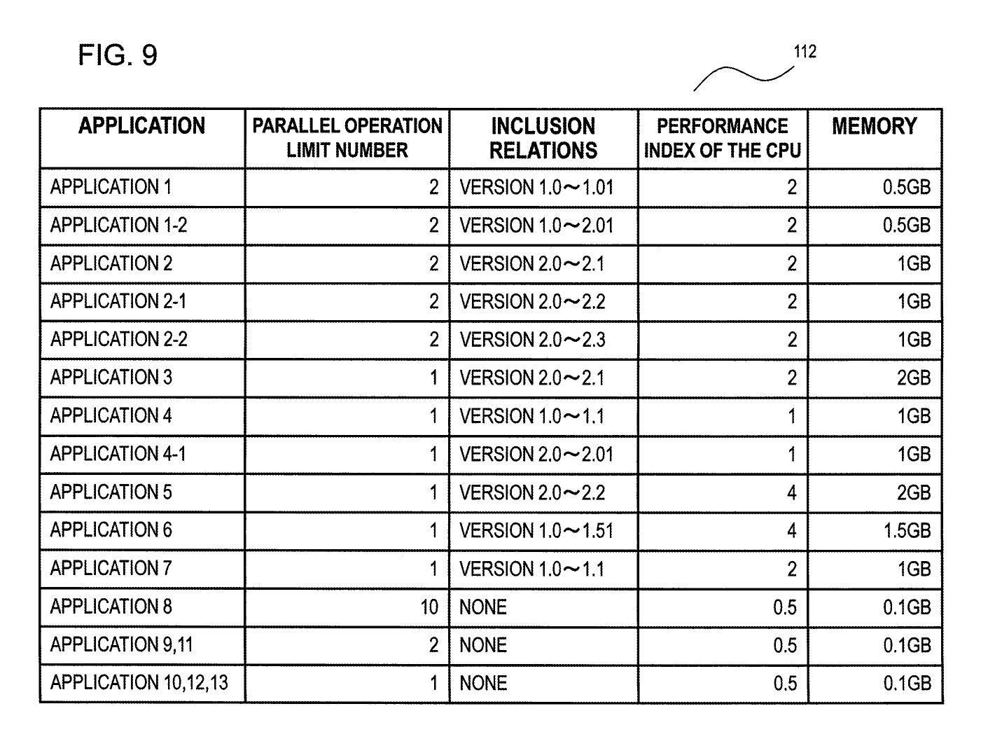

The application information list (below, called as application information list 112) in the application information list storage domain 112 has information of the application which carries out the processing of the sensor data. The application information list 112 is a database, for example. More details about application information list 112 will be described later according to FIG. 9.

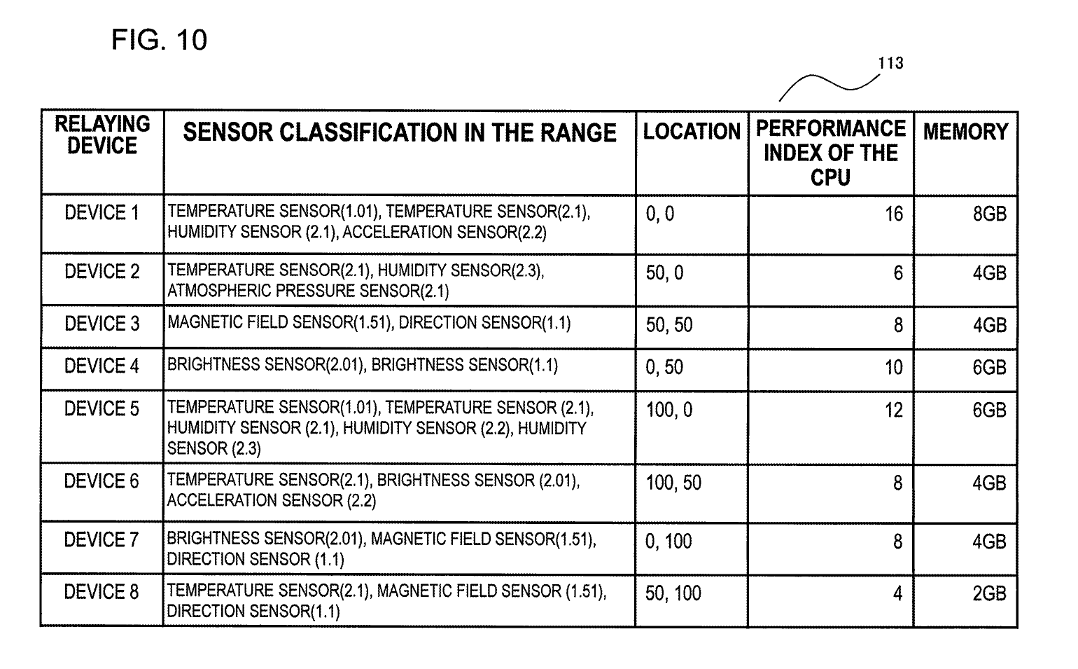

The relaying device information list (below, called as relaying device information list 113) in the relaying device information list storage domain 113 has information about the relaying device 20 in which the center server 10 targets for the management. The relaying device information list 113 is a database, for example. More details about relaying device information list 113 will be described later according to FIG. 10.

[Sensor Information List]

FIG. 8 is a diagram explaining an example of the sensor information list 111 which is illustrated in FIG. 7. The sensor information list 111 has the information about the target sensor of which the center server 10 collects sensor data. The sensor information list 111 depicted in FIG. 7 has the information of a kind of the sensor, a version of the sensor, and identification name of the application program (below, called as application) which carries out the processing the sensor data in which the sensor detects. The application is an application to carry out the processing prescribed depending on the sensor as mentioned above. In addition, the sensor information list 111 may have the information such as the vendors of the sensor more.

In the sensor information list 111 depicted by example of FIG. 8, the application, which carries out the processing of the sensor data in which the temperature sensor of version “1.01” detects, is the application 1, 8 and 9, as mentioned above in FIG. 2. In addition, in the sensor information list 111, the application, which carries out the processing of the sensor data in which the temperature sensor of version “2.1” detects, is the application 1-2, 8 and 9. Similarly, the application, which carries out the processing of the sensor data in which the humidity sensor of version “2.1” detects, is the application 2, 8 and 9. The sensor information list 111 in FIG. 8 has information about other sensors equally.

[Application Information List]

FIG. 9 is a diagram explaining an example of the application information list 112 depicted in FIG. 7. The application information list 112 has information of each application which carries out the processing of sensor data. The application information list 112 depicted in FIG. 9 has a identification name of application, a parallel operation limit number of applications, inclusion relations, a performance index of the CPU, and information of the memory.

The identification name of the application is same as that in the sensor information list 111 depicted in FIG. 8. The parallel operation limit number indicates the number of same applications which is executable in one relaying device 20 at the same time. In addition, the performance index of the CPU indicates an index of the performance of the CPU required for the execution of the application. The memory indicates capacity (Giga Byte: GB) of the memory to use for the execution of the application. The inclusion relation indicates the inclusion relation between the versions of the application of the same classification.

In FIG. 9, for example, the inclusion-relation “version 1.0-2.01” of the application 1-2 indicates that the application 1-2 includes “version 1.0-2.01”. In other words, it indicates that the application 1-2 includes a function of the application 1 and the processing of application 1 is executable.

In addition, in the application information list 112 depicted by the example of FIG. 9, the parallel operation limit number of the application 1 is value “2”. Therefore, two number of the application 1 is executable in same relaying device 20 at the same time. In addition, it indicates that the performance index of the CPU required for the execution of the application 1 is value “2” and the memory capacity of “0.5 GB” is used for the execution of application 1.

In addition, in the application information list 112 depicted by the example of FIG. 9, the parallel operation limit number of the application 3 is value “1”. Therefore, it is not possible to execute two or more number of the application 3 in same relaying device 20 at the same time. On the other hand, the parallel operation limit number of the application 8 is value “10”. Therefore, the application 8 till ten number is executable in same relaying device 20 at the same time. The application information list 112 depicted in FIG. 9 has information about other application likewise.

[Relaying Device Information List]

FIG. 10 is a diagram explaining an example of relaying device information list 113 depicted in FIG. 7. The relaying device information list 113 has information about the relaying device 20 of which the center server 10 targets for the management. In FIG. 10, the relaying device information list 113 has an identification name of the relaying device 20, the sensor classification in the range, positional information (Location), performance index of the CPU, information of the memory. In addition, the relaying device information list 113 has information of the physical machine 40 (40-1-40-5 in FIG. 6) equipped with the virtual machine when realizing the relaying device 20 according to the virtual machine.

The sensor classification in the range indicates the identification name of the sensor which the virtual machine (relaying device 20) equipped with the physical machine 40 (also called as the device) targets for the processing. The identification name of the sensor is information including the kind and the version of the sensor in the sensor information list 111 depicted in FIG. 8. The positional information indicates relative position (x,y) of the device of which the predetermined position is a base point. The performance index of the CPU indicates an index level of the performance of the CPU equipped with the device, and the memory indicates capacity of the memory equipped with the device.

In the relaying device information list 113 depicted in FIG. 10, the sensor classification in the range of the device 1 is a temperature sensor (1.01), a temperature sensor (2.1), a humidity sensor (2.1), and an acceleration sensor (2.2). In other words, it indicates that the device 30, which is equipped with the temperature sensor (1.01), the temperature sensor (2.1), the humidity sensor (2.1), and the acceleration sensor (2.2), is located in an appointed distance range from the position (0,0) of the device 1. In addition, the performance index of the CPU in the device 1 is value “16”, and the capacity of memory is value “8 GB”.

In addition, in the relaying device information list 113 depicted in FIG. 10, the device 30, which is equipped with a temperature sensor (2.1), a humidity sensor (2.3), and an atmospheric pressure sensor (2.1), is located in an appointed distance range from position (50,0) of the device 2. In addition, the performance index of the CPU is value “6”, and the capacity of the memory is value “4 GB”. The relaying device information list 113 has similar information about other devices.

[Software Block Diagram of Central Server]

FIG. 11 is a software block diagram of virtual machine deployment program 110 in the center server 10 depicted in FIG. 7. In FIG. 11, same elements as represented by FIG. 7 are indicated by same signs in FIG. 7.

As represented by FIG. 11, the virtual machine deployment program 110 explained by FIG. 7 has a sensor application information management module 121, a relaying device information management module 122, a deployment instruction creation module 123, and a virtual machine deployment control module 124. The details of the processing of each module 121-124 will be described later according to a flow chart diagram in FIG. 16.

The sensor application information management module 121 stores the information of the sensor, of which the center server 10 targets for the management, in the sensor information list 111 (referring to FIG. 8). In addition, the sensor application information management module 121 receives information of the application of which the center server 10 targets for the management through internet 50, etc. along the communication interface unit 103 and stores it in the application information list 112 (referring to FIG. 9). In addition, the sensor application information management module 121 associates information of the application with the sensor and updates the sensor information list 111 and the application information list 112 depending on the movement of the sensor, etc.

The relaying device information management module 122 stores the information of relaying device 20 of which the center server 10 targets for the management in the relaying device information list 113 (referring to FIG. 10). The relaying device information management module 122 updates the relaying device information list 113 depending on the movement and addition of the device 30.

The deployment instruction creation module 123 creates the deployment plan of the virtual machine with reference to the sensor information list 111, the application information list 112 and the relaying device information list 113. The deployment plan of the virtual machine includes information of the number of the virtual machines to deploy to each physical machine 40 (device) and information of the application installed on each virtual machine. In addition, the deployment instruction creation module 123 generates the deployment instruction of the virtual machine based on the deployment plan and outputs it to the virtual machine deployment control module 124.

The virtual machine deployment control module 124 deploys the virtual machine indicating the relaying device 20 to the physical machine 40 based on the deployment instruction. In addition, the virtual machine deployment control module 124 notifies each relaying device 20 of the identification information of the sensor that the relaying device 20 concerned targets for the collection of sensor data based on the deployment plan.

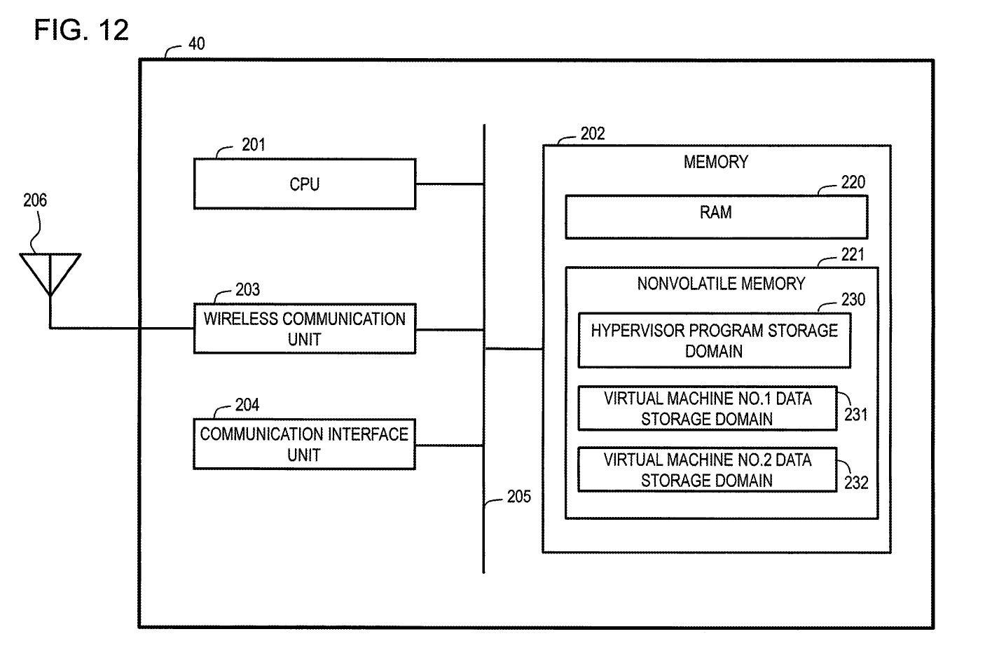

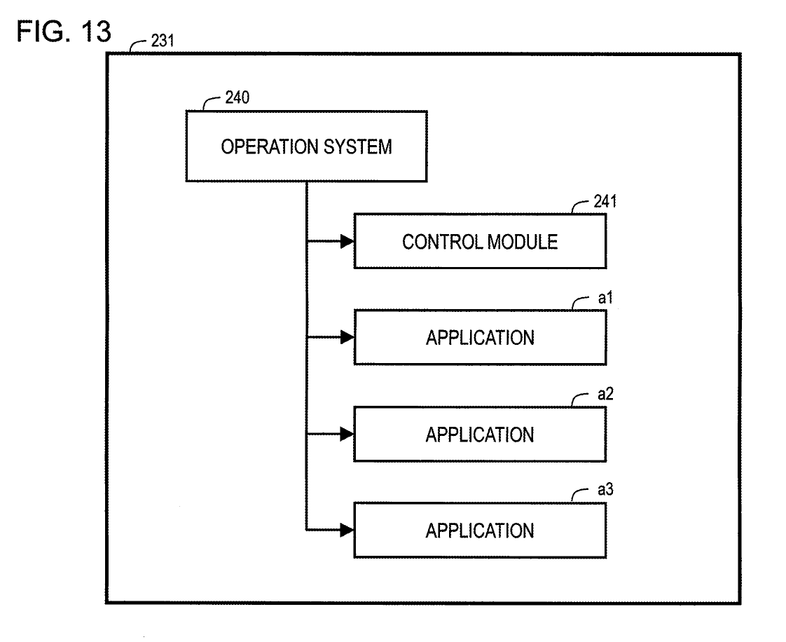

Then, according to FIG. 12 and FIG. 13, the hardware constitution and the software block the physical machine 40 having the relaying device 20 depicted in FIG. 6 will be described. FIG. 12 and FIG. 13 exemplifies an example of single physical machine 40, but other physical machine 40 is similar, too.

[Hardware Constitution of the Relaying Device]

FIG. 12 is a diagram of hardware constitution of physical machine 40 having the relaying device 20 depicted by FIG. 6. In FIG. 12, the physical machine 40 has a CPU 201, a memory 202, a wireless communication unit 203, and a communication interface unit 204, for example. The all parts are connected through a bus 205 mutually. The memory 202 includes a RAM (Random Access Memory) 220 and a nonvolatile memory 221, etc. for example.

The wireless communication unit 203 carries out transmission and reception of data to the device 30 according to wireless communication through an antenna 206. In addition, the communication interface unit 204 carries out the transmission and reception of data to the center server 10 through cable communication. In addition, the radio communication unit 203 may transmit and receive the data to the central server 10 according to the wireless communication.

The CPU 201 is connected to the memory 202, etc. through the bus 205 and controls whole of the physical machine 40. The RAM 220 in the memory 202 memorizes the data of which the CPU 201 processes. The nonvolatile memory 221 in the memory 202 includes hypervisor program storage domain 230, virtual machine No. 1 data storage domain 231, virtual machine No. 2 data storage domain 232. The nonvolatile memory 221 has an HDD (Hard disk drive), and or a nonvolatile semiconductor memory.

The hypervisor program storage domain 230 stores hypervisor program (below, called as hypervisor program 230) which realizes processing of the hypervisor by an execution of the CPU 201 according to the present embodiment.

The virtual machine No. 1 data storage domain 231 stores virtual machine No. 1 data (below, called as virtual machine No. 1 data 231) which is referred and updated by the hypervisor program 230 and works as the first virtual machine indicating the relaying device 20. The virtual machine No. 1 data 231 includes application program that the first virtual machine carries out. The virtual machine No. 2 data storage domain 232 stores virtual machine No. 2 data (below, called as virtual machine No. 2 data 232) which is referred and updated by the hypervisor program 230 and works as the second virtual machine indicating the relaying device 20. The virtual machine No. 2 data 232 includes application program that the second virtual machine carries out.

[Software Block Diagram of Relaying Device]

FIG. 13 is a software block diagram of virtual machine No. 1 data 231 depicted by FIG. 12. In FIG. 13, the same elements as that represented by FIG. 12 are indicted by same sign in FIG. 12. In addition, the software block diagram of the virtual machine No. 2 data 232 depicted by FIG. 12 is similar to that of the virtual machine No. 1 data 231.

As illustrated in FIG. 13, the virtual machine No. 1 data 231 has OS (operation system) 240, control module 241, and application programs a1-a3. The application program a1 corresponds to the application programs 1-2, and the application program a2 corresponds to the application program 8, and the application program a3 corresponds to the application program 9 which are exemplified by FIG. 2-FIG. 4.

The hypervisor program 230 depicted by FIG. 13 carries out the OS 240 based on the virtual machine No. 1 data 231 and operates the control module 241 and the application programs a1-a3 on the OS 240. The control module 241 receives the sensor data of which the device 30 sent based on the identification information of the sensor that own relaying device 20 is targeted for collection, and delivers it to the corresponding application program a1-a3.

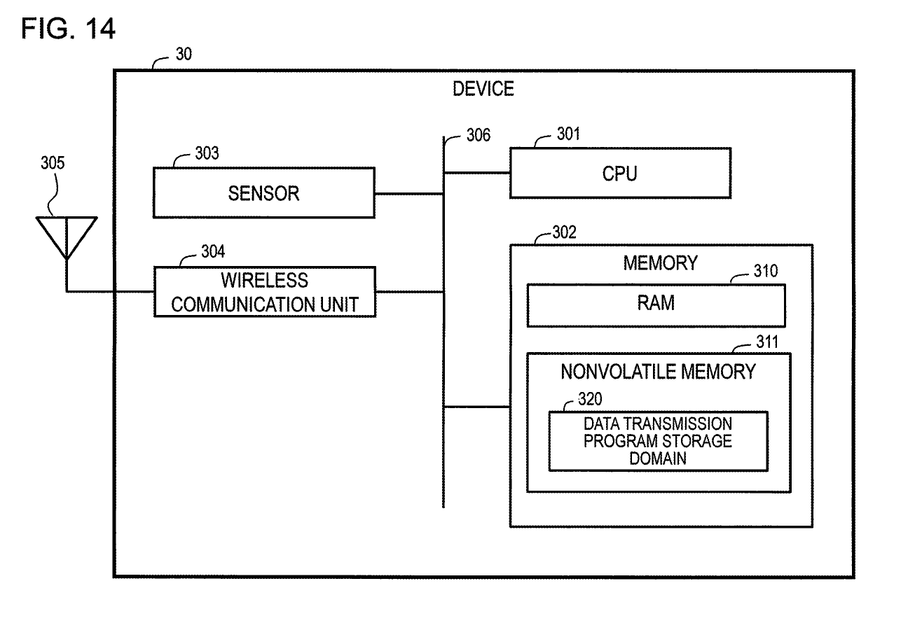

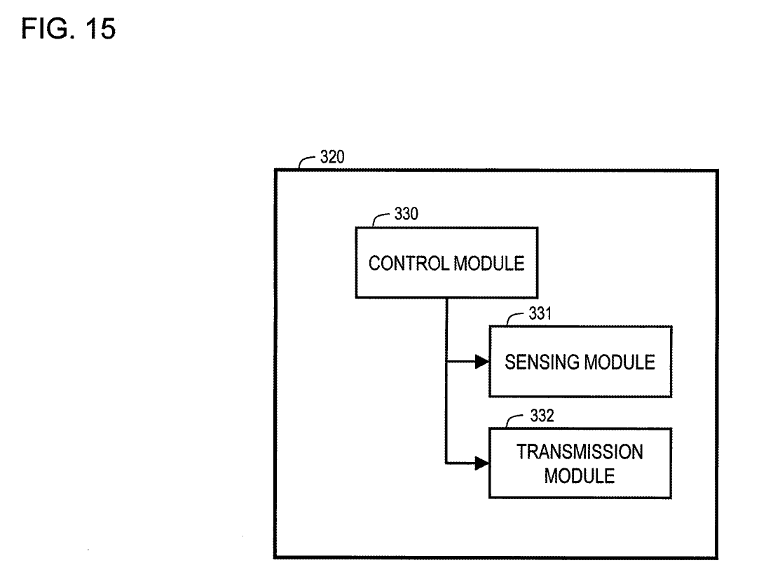

Then, according to FIG. 14, FIG. 15, the hardware constitution and the software block diagram of the device 30 depicted by FIG. 6 will be described. In addition, FIG. 14 and FIG. 15 represents an example of single device 30, but other device 30 is similar to the single device 30. FIG. 14 and FIG. 15 indicate an example of wearable device.

[Hardware Constitution of the Device]

FIG. 14 is a diagram of the hardware constitution of the device 30 depicted by FIG. 1 and FIG. 6. The device 30 depicted in FIG. 14 has a CPU 301, a memory 302, a sensor 303, a wireless communication unit 304, and an antenna 305, for example. The all parts are connected through a bus 306 mutually. The memory 302 includes a RAM (Random Access Memory) 401 and a nonvolatile memory 402, etc.

The CPU 301 is connected to the memory 302, etc. through the bus 306 and controls whole of the device 30. The sensor 303 is a detection unit which detects the measurement information such as temperature, humidity, living body data, etc. For example, the sensor 303 is a temperature sensor, a humidity sensor, a living body sensor. The wireless communication unit 304 carries out the transmission and reception of data to the relaying device 20 according to the wireless communication through the antenna 305. The antenna 305 transmits and receives various data by the radio beam.

The RAM 310 in the memory 302 memorizes the data of which the CPU 301 processes. The nonvolatile memory 311 in the memory 302 includes a domain (not illustrated in FIG. 14) storing the program of the OS that the CPU 301 carries out. In addition, the nonvolatile memory 311 includes data transmission program storage domain 320. For example, the nonvolatile memory 311 is a nonvolatile semiconductor memory. The data transmission program (below, called as data transmission program 320) which stored in the data transmission program storage domain 320 realizes acquisition processing and transmission processing of sensor data by the execution of the CPU 301.

[Software Block Diagram of the Device]

FIG. 15 is a diagram of constitution of the software block of device 30 depicted by FIG. 14. In FIG. 15, the same elements as that represented by FIG. 14 are indicted by same sign in FIG. 14. As illustrated in FIG. 15, the data transmission program 320 depicted by FIG. 14 has control module 330, sensing module 331, and transmission module 332.

The control module 330 outputs the acquisition instruction of the sensor data to the sensing module 331 regularly. The sensing module 331 acquires the sensor data of which the sensor 303 (referring to FIG. 14) detected depending on the instruction of the control module 330. The transmission module 332 sends the sensor data of which the sensing module 331 acquired to the relaying device 20 through the wireless communication.

Then, a flow of the processing of the virtual machine deployment program 110 in the center server 10 depicted by FIG. 11 will be described according to FIG. 16. In the present embodiment, a case to realize the relaying device 20 by a virtual machine will be described.

[Processing of Virtual Machine Deployment Program]

FIG. 16 is a diagram of flow chart explaining the processing of the virtual machine deployment program 110 in the center server 10 depicted in FIG. 11.

S11: A deployment order making module 123 in the virtual machine deployment program 110 makes the deployment plan PL of the virtual machine according to processing No. 1.

The deployment order making module 123, as described above in FIG. 3 and FIG. 4 as the processing No. 1, selects the relaying device 20 of each sensor, which has fewer totals of the processing prescribed for one or the plural sensors that is targeted for the processing in the plurality of relaying devices (virtual machine), as a candidate. Thereby, it is possible to minimize the total number of application programs to equip in the relaying device 20 and to utilize a resource of the relaying device 20 effectively.

In addition, the deployment order making module 123 according to the present embodiment selects the relaying device 20, in which the parallel number of processing (application) in the relaying device does not exceed the number of the parallel operations limit according to the processing, as a candidate. Each application program has the parallel operation limit number as described above in the application information list 112 (referring to FIG. 9). The application program is not able to work more than the parallel operation limit number in one relaying device. Therefore, when the number of applications to work in the relaying device exceeds the parallel operation limit number, competition (conflict) of the application programs which carry out the processing of sensor data, occurs between the sensors and a case which is not carried out the processing of sensor data appropriately may occurs.

Therefore, by selecting the relaying device 20 of each device 30 to meet the parallel operation limit number of applications, it is possible to select with the relaying device 20 of each sensor to utilize a resource of relaying device 20 effectively while evading the competition of the resource in the relaying device. Accordingly, it is possible that the relaying device 20 processes the sensor data of the target sensor surely.

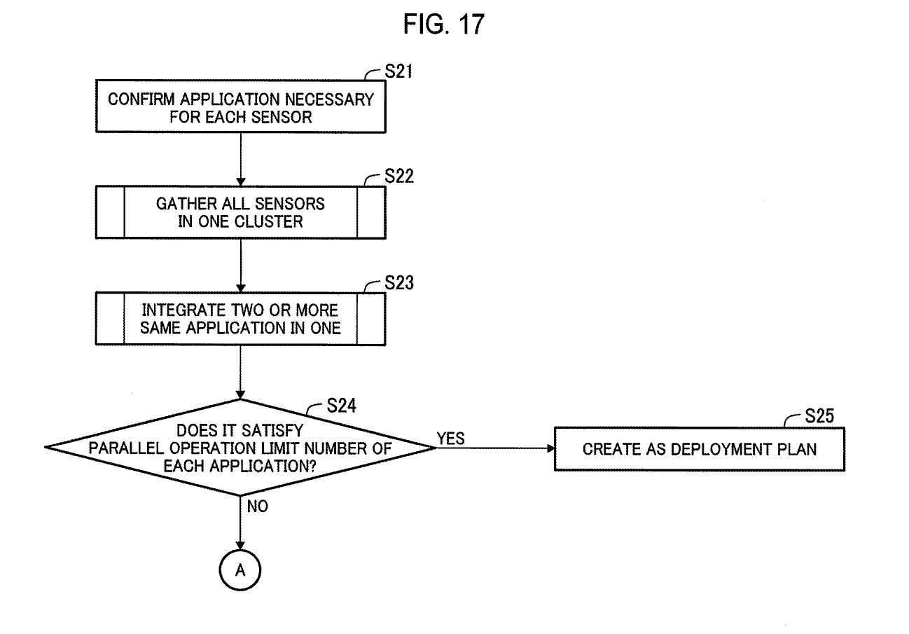

In addition, the deployment order making module 123 may calculate the number of the deployments of the virtual machine meeting the parallel operation limit number of applications more, and may select the candidate of relaying device 20 among the plurality of virtual machines of the number of the deployments which are calculated. Therefore, it is possible that the deployment order making module 123, by integration of the application, sets the number of the deployments of the virtual machine to a minimum value to meet the parallel operation limit number. Accordingly, it is possible to use a resource of physical machine 40 deploying the virtual machine effectively while satisfying the limit of the application. The details of processing No. 1 in the process S11 will be described later according to FIG. 17-FIG. 20.

S12: The deployment order making module 123 determines whether or not the deployment plan PL, which is made according to the process S11, meets a condition of the number of the performance of each relaying device 20 and the simultaneous connection. The performance of relaying device 20 is, for example, a resource of the hardware of relaying device 20 and is a performance index of the CPU and the memory. The number of the simultaneous connections is a number of devices 30 which is accessible to the relaying device 20 at the same time which is set depending on a resource and hardware of the relaying device 20, for example.

S13: When the condition is not satisfied (No of S12), the deployment order making module 123 creates representation plan of some sensors according to the processing No. 2. In addition, the deployment order making module 123 does not processes the process S13 when the condition is satisfied (Yes of S12).

When the application works more than a value of the performance index of the CPU and the memory of the device which are explained in relaying device information list 113 of FIG. 10, the competition (conflict) of the resource of the relaying device 20 between applications or between the devices may occur. Therefore, the application does not work appropriately, and the state that the relaying device 20 does not process the sensor data of some device 30 may occur.

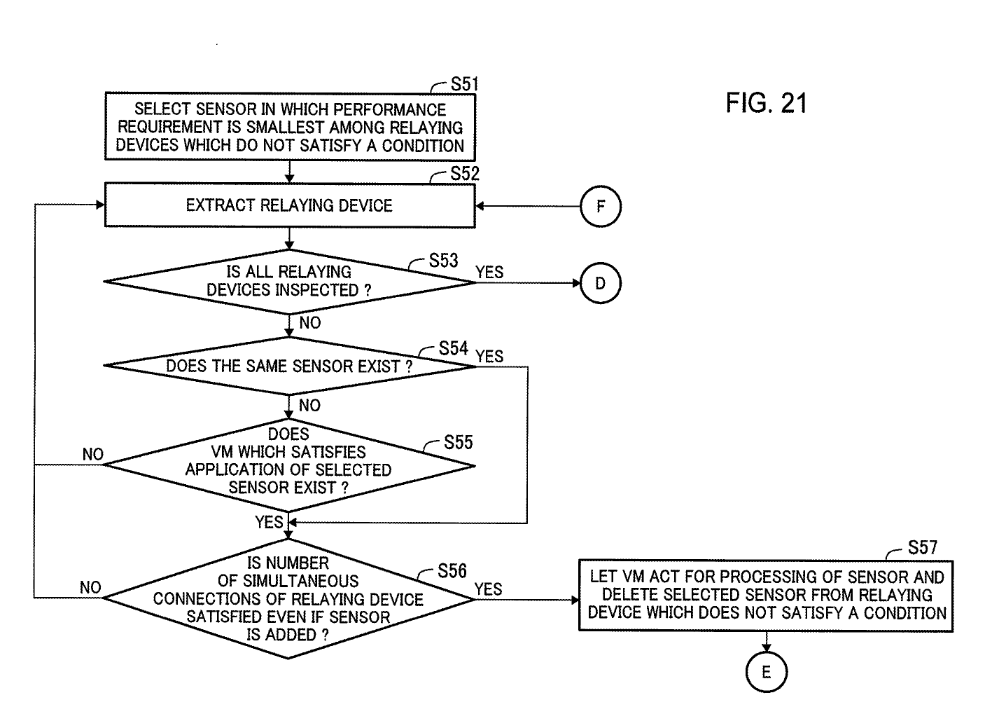

Therefore, in the process S13, the deployment order making module 123, makes that different relaying device 20 carries out the processing of some sensors in which the relaying device 20, which does not meet a condition of the performance and the number of the connections at the same time, targets for the processing. Accordingly, it is possible to avoid the competition of the resource between the applications or the devices, and to carry out the processing of sensor data of each sensor surely. Therefore, it is possible to select the relaying device 20 of each sensor so as to meet the condition of performance of relaying device 20 and the simultaneous connection number while utilizing a resource of relaying device 20 effectively. The details of processing No. 2 in the process S13 will be described later according to FIG. 21-FIG. 24.

S14: The virtual machine deployment control module 124 instructs the deployment of the virtual machine to the physical machine according to the deployment plan and orders installation of the application for the virtual machine. The relaying device 20 collects and processes the sensor data of each device 30 and transmits to the center server 10.

S15: The virtual machine deployment control module 124 determines whether or not the device 30 moved.

S16: When the device 30 moved (Yes of S15), the sensor application information management module 121 updates the sensor information list 111 (referring to FIG. 8) and the application information list 112 (referring to FIG. 9). And the deployment order making module 123 selects the relaying device 20 which carries out the processing of the sensor in which moved device is equipped with according to processing No. 3, with reference to the sensor information list 111 and the application information list 112.

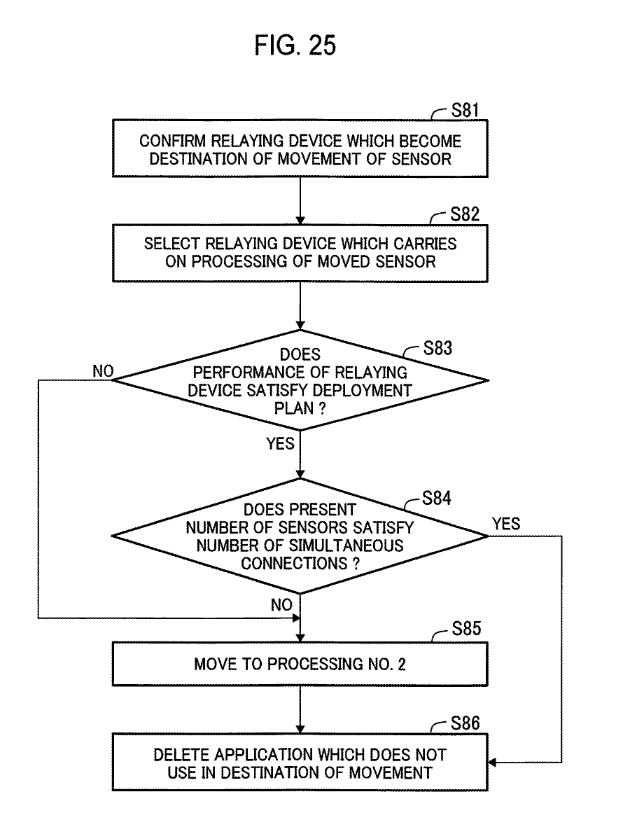

The deployment order making module 123, as the processing No. 3, selects the relaying device 20 that the number of the processing, which is not included in a set of a plurality of the processing of sensors that the relaying device 20 targets among a plurality of the processing prescribed depending on a sensor of device 30 which moved, is less, as a candidate. The details of the processing in the process S16 will be described later according to FIG. 25. In addition, the relaying device information management module 122 updates the relaying device information list 113 depending on the change of the sensor that the relaying device 20 targets for processing.

According to FIG. 17-FIG. 20, a flow of processing No. 1 of the deployment order making module 123 (S11 of FIG. 16) depicted in FIG. 11 will be described in detail.

[Flow of Processing No. 1]

FIG. 17 is a diagram of first flow chart explaining a flow of processing No. 1 of the deployment order making module 123 (S11 of FIG. 16) depicted in FIG. 11.

S21: The deployment order making module 123 detects each sensor which are equipped with each device 30 of the object selecting the relaying device 20. In addition, the deployment order making module 123 acquires (confirms) a list of application to carry out the processing prescribed depending on each sensor with reference to the sensor information list 111 (referring to FIG. 8).

S22: The deployment order making module 123 gathers up each sensor which are detected to one cluster.

S23: The deployment order making module 123 integrates the same application, of which a cluster created in the process S22 includes, for one application.

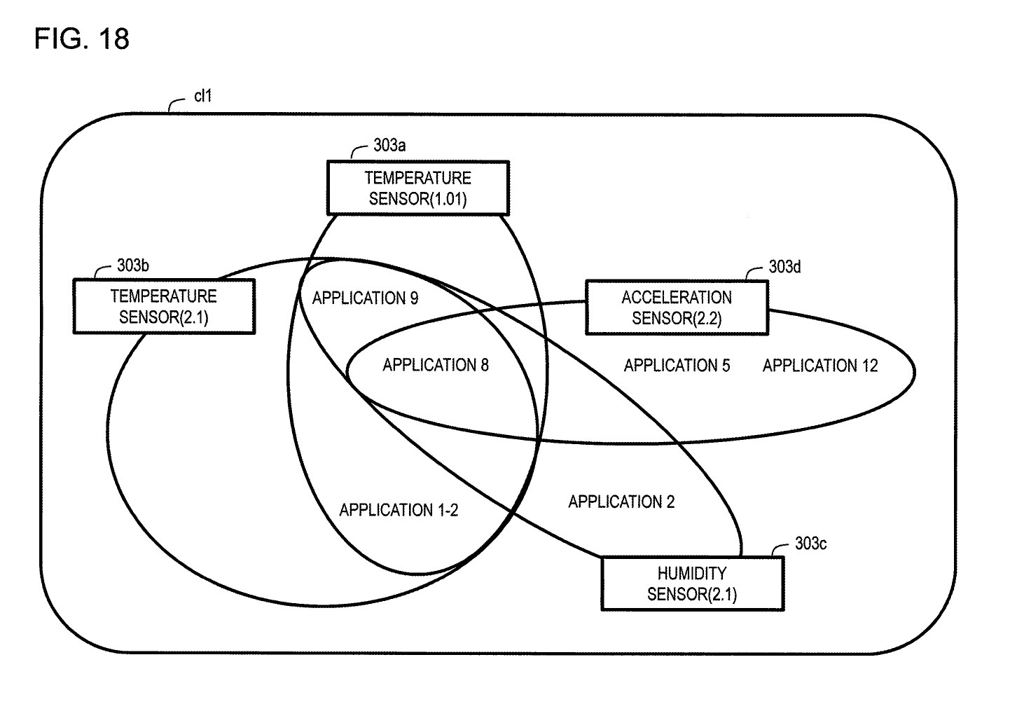

FIG. 18 is a diagram explaining the process S22, S23 of FIG. 17. In FIG. 18, the same elements as that represented by FIG. 3 and FIG. 4 are indicted by same sign in FIG. 3 and FIG. 4. The present embodiment exemplifies a case to select relaying device 20 of four sensors depicted in FIG. 2. Four sensors are the temperature sensor (1.01) 303a, the temperature sensor (2.1) 303b, the humidity sensor (2.1) 303c, and the acceleration sensor (2.2) 303d as mentioned above in FIG. 2.

As illustrated in FIG. 18, the deployment order making module 123 gathers up four sensors in one cluster cl1 (S22 of FIG. 17). In addition, as represented by FIG. 18, the deployment order making module 123 integrates common application between sensors (in the example of FIG. 18, application 8, 9) as one application (S23 of FIG. 17). In addition, the application 1-2 includes the application 1. Therefore, the deployment order making module 123 integrates the application 1-2 and the application 1 in the application 1-2 (S23 of FIG. 17). Explanation returns to a diagram of flow chart in FIG. 17.

S24: The deployment order making module 123, with reference to the application information list 112 (referring to FIG. 9), determines whether or not each application of which the cluster cl1 created in the process S23 has meets the parallel operation limit number. In other words, the deployment order making module 123 determines whether or not the total number of same applications that the cluster cl1 depicted in FIG. 18 has is less than the number of the parallel operation limits of the application concerned.

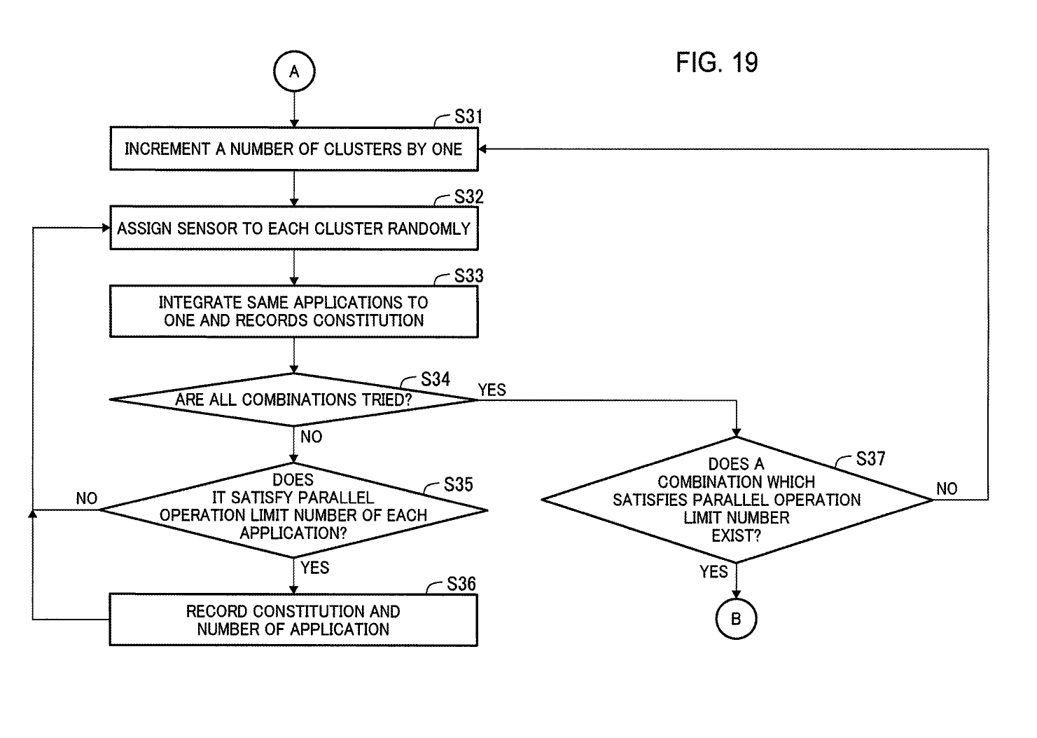

According to the application information list 112 (referring to FIG. 9), the parallel operation limit number of application 8 is value “10”, the parallel operation limit number of application 9 is value “2”, and the number of the parallel operation limits of application 1-2 is value “2”. According to the cluster cl1 of FIG. 18, the number of the parallel operation of application 9 to be common with three sensors (the temperature sensor (1.01), the temperature sensor (2.1), and the humidity sensor (2.1)) becomes value “3”, therefore the number of the parallel operation of application 9 does not meet number of the parallel operation limits “2” (No of S24). When not meeting the parallel operation limit number (No of S24), the process of the deployment order making module 123 moves in FIG. 19.

S25: On the other hand, when meeting the parallel operation limit number (Yes of S24), the deployment order making module 123 creates the deployment plan based on the cluster. In other words, the deployment order making module 123 deploys one virtual machine corresponding to one cluster and creates the deployment plan to deploy each application in the cluster to the virtual machine concerned.

FIG. 19 is a diagram of second flow chart explaining a flow of the processing No. 1 of deployment order making module 123 (S11 of FIG. 16) depicted in FIG. 11.

S31: When not meeting the parallel operation limit number ((A), No of S24 in FIG. 17), the deployment order making module 123 increases the number of clusters one.

S32: The deployment order making module 123 randomly assigns the sensor of which an existing cluster includes in the cluster which is increased. For example, the deployment order making module 123 assigns the sensor to two clusters represented in the first selection example depicted in FIG. 3. In other words, the deployment order making module 123 assigns the temperature sensor (1.01) 303a and the humidity sensor (2.1) 303c to the first cluster and assigns the temperature sensor (2.1) 303b and the acceleration sensor (2.2) 303d to the second cluster.

S33: The deployment order making module 123 integrates the same application for one application about each cluster like the process S23 of FIG. 17. In addition, the deployment order making module 123 records the constitution indicating the combination of cluster and applications which assigns to the cluster concerned.

S34: The deployment order making module 123 determines whether or not the inspection of the process S35 is carried out for all the combinations of cluster and applications.

S35: When the inspection for all combination is not completed (No of S34), the deployment order making module 123 determines whether or not the combination which are recorded in the process S33 meets the condition of the parallel operation limit number of the application.

S36: When meeting the condition of the parallel operation limit number (Yes of S35), the deployment order making module 123 records the application of each cluster and a total number of the applications of which the plurality of clusters include corresponding to the combination of cluster and application.

According to the first selection example in FIG. 3, the number of the parallel operations of each application that the first and second clusters include meets a condition of the number of the parallel operation limits (Yes of S35). Therefore, the deployment order making module 123 memorizes the combination that the application 1, 2, 8 and 9 correspond with the first cluster and the application 1-2, 5, 8, 9 and 11 corresponds with the second cluster. In addition, the deployment order making module 123 records the total number of applications [=“9” (=4+5)] of the first and second clusters.

When not meeting the parallel operation limit number (No of S35) or after the process S36, the process of the deployment order making module 123 moves in the process S32 and carries out the assignment of the sensor to the plural clusters again.

S37: When the inspection is completed for all combination (Yes of S34), the deployment order making module 123 determines whether or not a combination of the cluster with the application which meets the parallel operation limit number existed. When not existing (No of S37), the deployment order making module 123 moves in the process S31, and increases the number of clusters one more. In other words, the deployment order making module 123 carries out the process S32-S37 based on three clusters.

The deployment order making module 123 assigns the sensor to two clusters according to the second selection example depicted in FIG. 4 (S32). In other words, the deployment order making module 123 assigns the temperature sensor (1.01) 303a and the temperature sensor (2.1) 303b to the first cluster and assigns the humidity sensor (2.1) 303c and the acceleration sensor (2.2) 303d to the second cluster.

In addition, according to the second selection example depicted in FIG. 4, the number of the parallel operations of each application that the first and second cluster includes meets a condition of the number of the parallel operation limits (Yes of S35). Therefore, the deployment order making module 123 records the combination that the application 1-2, 8 and 9 correspond with the first cluster and the application 2, 5, 8, 9 and 11 correspond with the second cluster (S36). In addition, the deployment order making module 123 records the total number of applications of the first and second clusters [=“8” (=3+5)].

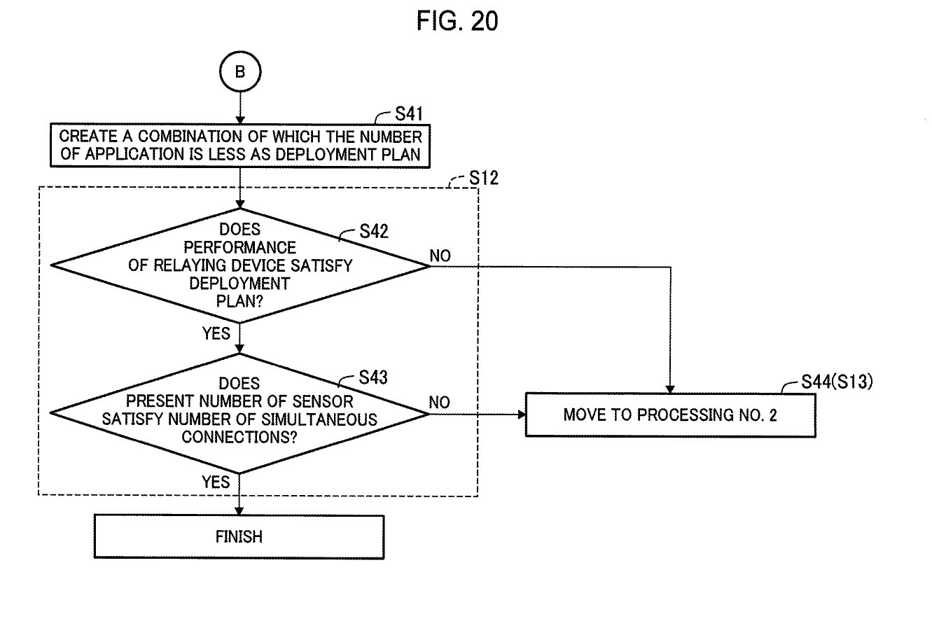

When a combination meeting the parallel operation limit number exists (Yes of S37), the process of deployment order making module 123 moves in a diagram of flow chart (B) in FIG. 20.

FIG. 20 is a diagram of third flow chart explaining a flow of processing No. 1 of deployment order making module 123 (S11 of FIG. 16) depicted in FIG. 11.

S41: The deployment order making module 123 selects the combination which is smaller total number of applications among the plural combinations which are recorded, and creates the deployment plan based on the combination which are selected.

The total number of applications of the first selection example depicted in FIG. 3 is value “9”, and the total number of the applications of the second selection example depicted in FIG. 4 is value “8”. Therefore, the deployment order making module 123 creates the deployment plan based on the second selection example. The deployment plan has information to deploy two virtual machines to the device 1 and deploy the applications 1-2, 8 and 9 to the first virtual machine and deploy the application 2, 5, 8, 9, 11 to the second virtual machine.

In this way, the deployment order making module 123 calculates a total number of the processing prescribed depending on the sensor in which the plurality of relaying devices 20 targets for the processing based on the first combination of each sensor and the relaying device 20. In addition, the deployment order making module 123 calculates a total number of the processing prescribed depending on the sensor in which the plurality of relaying devices 20 targets for the processing based on the different second combination. And the deployment order making module 123 compares the total number of processing based on the first and second combinations and selects a candidate of relaying device 20 based on the combination that there are few total numbers.

Thereby, it is possible that the deployment order making module 123 minimizes the total number of applications which are deployed in the relaying device 20. In addition, it is possible that the deployment order making module 123 sets the number of virtual machines to deploy to a minimum value to meet the parallel operation limit number of applications. Therefore, it is possible to control the total number of applications and the number of the virtual machines to deploy in a minimum while meeting a condition of the application, and to use a resource effectively.

S42: The deployment order making module 123 judges whether or not the deployment plan which is created meets a condition of the performance of the relaying device 20. In addition, the judgment processing of S42 and S43 correspond with the process S12 of the diagram of flow chart in FIG. 16.

In more detail, the deployment order making module 123 acquires the resource (the performance index of the CPU, memory) of the device with reference to the relaying device information list 113. In addition, the deployment order making module 123 acquires quantity of use resource (the performance index of the CPU, memory) of the application based on the deployment plan with reference to the application information list 112 (referring to FIG. 9). And the deployment order making module 123 judges whether or not the total of the quantity of resource to use based on the deployment plan is settled within the resource of the device.

The deployment plan indicating the second selection example depicted in FIG. 4 will be explained in the example. According to the application information list 112 (referring to FIG. 9), the total of the performance index of the CPU, of which the applications 1-2, 8 and 9 to deploy to the first virtual machine, use, is value “3” (=2+0.5+0.5). In addition, the total of capacity of the memory, of which the applications 1-2, 8 and 9 to deploy to the first virtual machine use, is “0.7 GB” (=0.5+0.1+0.1). Similarly, the total of the performance index of the CPU, of which the applications 2, 5, 8, 9 and 11 to deploy to the second virtual machine use, is value “7.5”, and the total of the capacity of the memory to use is “3.3 GB”.

Therefore, the total of the performance index of the CPU of which the application to work with the device 1 uses is value “10.5 (=3+7.5)”, and the total of the capacity of the memory to use is value “4.0 (=0.7+3.3) GB”. In contrast, according to the relaying device information list 113 (referring to FIG. 10), the performance index of the CPU of the device 1 is value “16”, and the capacity of the memory is value “8 GB”. Therefore, the gross weight of the resource used by the application to work with device 1 is settled within the resource of device 1 (Yes of S42).

A case when the deployment plan which is created does not meet the condition of the performance of the relaying device 20 will be exemplified (No of S42). When the performance index of the CPU in the device 1 is not value “16”, but the value “11” and the capacity of the memory is not value “8 GB”, but value “4.5 GB” and a brightness sensor (2.01) is provided with the processing object more, the deployment plan does not meet the condition of the performance of the device value (No of S42).

According to the application information list 112 (referring to FIG. 9), the application which processes the sensor data of the brightness sensor (2.01) are the applications 4-1, 8, 11. For example, when the second virtual machine processes the sensor data of the brightness sensor (2.01) more, the second virtual machine is equipped with the application 4-1 more. The performance index of the CPU of the application 4-1 is value “1”, and the use memory is value “1 GB”.

Therefore, the total of the performance index of the CPU, that the application to work with the device 1 uses, is value “11.5” (=10.5+1), and the total of the memory to use is value “5.0 (=4.0+1.0) GB”. Therefore, the deployment plan (the performance index of CPU is value “11.5” and the memory is value “5.0 GB”) does not meet a condition of the performance (the performance index of the CPU is value “11” and the memory is value “4.5 GB”) of device 1 (No of S42).

S43: When the deployment plan which is created meets a condition of the performance of the relaying device 20 (Yes of S42), the deployment order making module 123 judges whether or not the deployment plan which is created meets the condition of the simultaneous connection number of the relaying devices 20. In more detail, the deployment order making module 123 judges whether or not the number of devices 30 which is connected based on the deployment plan falls within the simultaneous connection number of the devices.

When meeting the condition of the performance of the relaying device 20 (Yes of S43), the deployment order making module 123 finishes the processing No. 1. And the deployment order making module 123 outputs the deployment order based on the deployment plan which is created to the virtual machine deployment control module 124.

For example, when the number of the simultaneous connections of device 1 is value “100”, and the number of devices 30 of which the device 1 targets for the processing based on the deployment plan is value “110” (No of S43), the simultaneous connection number of device 1 does not meet the number of the connections based on the deployment plan which is created.

S44: When the deployment plan which is created does not meet the condition of the number of the performance or the simultaneous connection of the relaying device 20 (No of S42, No of S43), the deployment order making module 123 carries out the processing No. 2. The processing of the process S44 corresponds to the process S13 of the diagram of flow chart in FIG. 16.

[Flow of Processing No. 2]

Then, according to FIG. 21-FIG. 24, a flow of processing No. 2 of the deployment order making module 123 (S13 of FIG. 16, S44 of FIG. 20) depicted in FIG. 16, FIG. 20 will be described in detail.

FIG. 21 is a diagram of first flow chart explaining a flow of processing No. 2 of the deployment order making module 123 (S13 of FIG. 16, S44 of FIG. 20) depicted in FIG. 11.

S51: The deployment order making module 123 selects the sensor in which the performance requirements is smallest among the sensors in which the relaying device 20, which does not meet the condition of the performance or the number of the connections at the same time, targets for the processing.

When not meeting the condition of the performance (No of S42 in FIG. 20), the deployment order making module 123 selects the sensor in which the performance index of the CPU and the memory is smallest among each sensor that the relaying device 20 targets for the processing, with reference to the application information list 112 (referring to FIG. 9). For example, according to the example depicted in the process S42 of FIG. 20, the sensor that the performance index of the CPU and the memory is smallest among five sensors that the device 1 targets for the processing is the brightness sensor (2.01).

On the other hand, when not meeting the condition of the number of the connections at the same time (No of S43 in FIG. 20), the deployment order making module 123 selects the sensor that there is the fewest number of devices 30. According to the example depicted in the process S43 of FIG. 20, there are the number of devices 30 equipped with the brightness sensor (2.01) is fewest among five sensors that the device 1 targets for the processing. For example, the number of devices 30 equipped with the brightness sensor (2.01) is ten.

S52: The deployment order making module 123 sequentially detects a device located in the nearer place from the sensor which is selected with reference to the positional information that the relaying device information list 113 (FIG. 10) has. For example, the deployment order making module 123 detects the device 2 located in the nearest place from the device 30 equipped with the brightness sensor (2.01). In addition, the deployment order making module 123 selects either device when a plurality of devices exist at the near position.

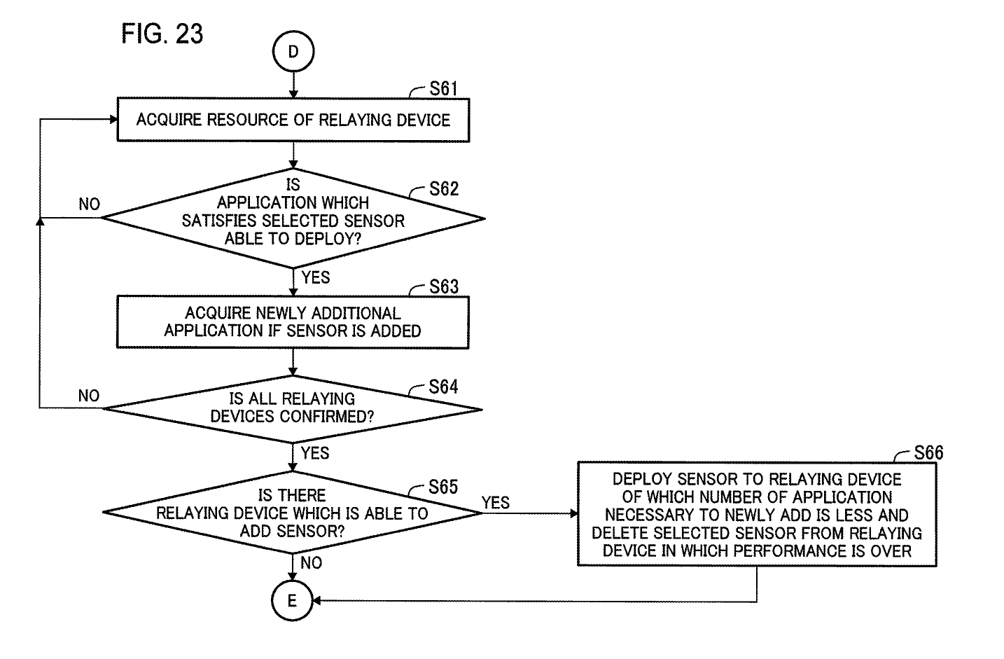

S53: The deployment order making module 123 determines whether or not the inspection (S54, S55) of the deputy for the processing of sensor data of the sensor which is selected about all the devices which is detected. When the inspection is completed (Yes of S53), that is, when the relaying device 20 which acts for the processing is not found, the processing of the deployment order making module 123 moves in a diagram of flow chart in FIG. 23.

S54: The deployment order making module 123 judges whether or not each virtual machine (the relaying device 20), of which the detected device carries out, targets the sensor which is the same as the sensor which is selected with the processing object. In other words, the deployment order making module 123 selects the relaying device 20 which targets the sensor which is the same as the sensor which is selected for the processing as the relaying device 20 which deputes for the processing of the sensor concerned.

Because of letting the relaying device 20, which targets the sensor which is the same as the sensor which is detected, depute of the processing of the sensor which is selected, it is not necessary to newly install the application to carry out the processing of the sensor in the relaying device 20. Therefore, it is possible that the deployment order making module 123 selects the relaying device 20 of the sensor, so as to use a resource of the relaying device 20 effectively.

S55: When the sensor data of the same sensor is not targeted for a processing object (No of S54), the deployment order making module 123 judges whether or not the virtual machine which is extracted carries out the application to carry out the processing prescribed depending on the sensor which is selected. In other words, the deployment order making module 123 selects the relaying device 20, which carries out the processing that is the same as the processing prescribed depending on the sensor which is selected, as the relaying device 20 deputing for the processing of the sensor concerned.

Because letting the relaying device 20, which carries out the processing that is the same as processing prescribed depending on the sensor which is selected, depute for the processing of the sensor which is selected, it is not necessary to newly install the application to carry out the processing of the sensor concerned in the relaying device 20. Therefore, it is possible that the deployment order making module 123 selects the relaying device 20 of the sensor so as to use a resource of relaying device 20 effectively.

When not carrying out the same processing (No of S55), the processing of the deployment order making module 123 moves in the process S52. In other words, the deployment order making module 123 detects a different device located in the next near place from the device 30 equipped with the sensor which is selected.

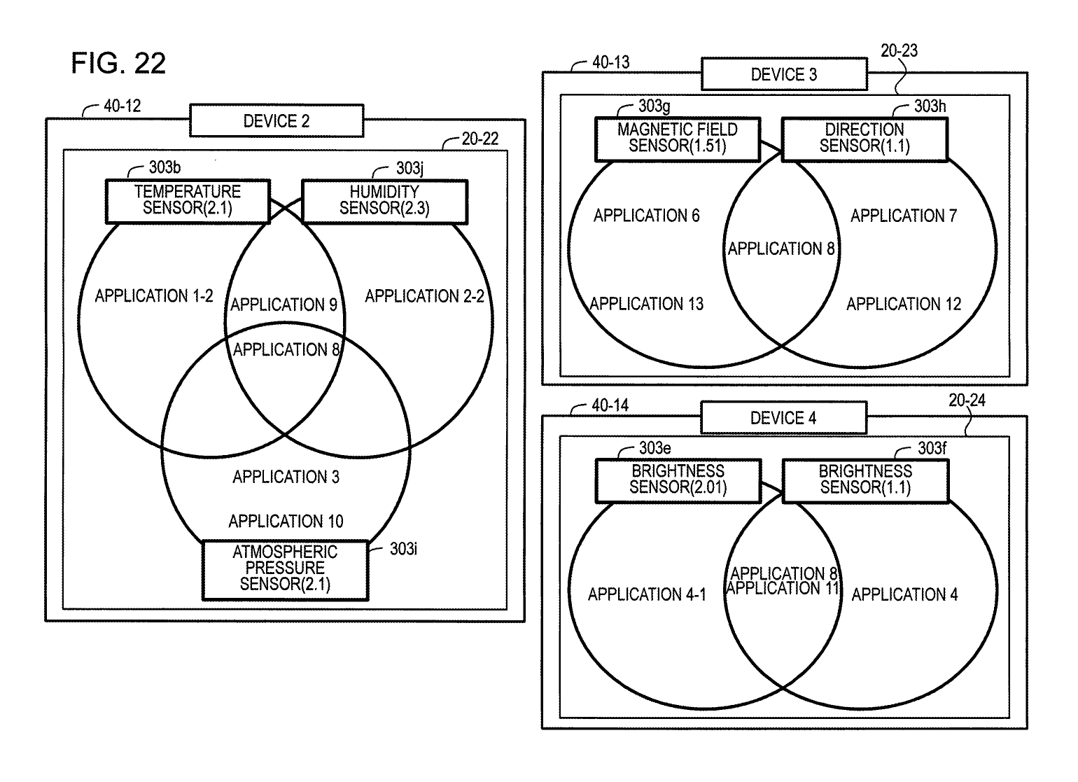

FIG. 22 is a diagram indicating the sensor that the device 2-4 in the present embodiment targets for the processing. As illustrated in FIG. 22, the device 2 (40-12) carries out one virtual machine 20-22, and does the sensor data of the temperature sensor (2.1) 303b, the humidity sensor (2.3) 303j, and the atmospheric pressure sensor (2.1) 303i for the target of the processing. In other words, the virtual machine 20-22 of the device 2 does not do the brightness sensor (2.01) 303e for the target for the processing (No of S54). In addition, the virtual machine 20-22 of the device 2 does not carry out the applications 4-1, 11 among the applications 4-1, 8, 11 which carry out the processing prescribed depending on the brightness sensor (2.01) 303e (No of S55).

Accordingly the deployment order making module 123 detects the device 3 (40-13) next (S52). according to the example of FIG. 22, the device 3 (40-13) carries out one virtual machine 20-23, and does the magnetic field sensors (1.51) 303g, and the direction sensor (1.1) 303h for target of the processing. Therefore, the virtual machine 20-23 of the device 3 does not do the brightness sensor (2.01) 303e target for the processing (No of S54). In addition, the virtual machine 20-23 of the device 3 does not carry out the applications 4-1, 11 (No of S55).

Next, the deployment order making module 123 detects the device 4 (40-14) next (S52). According to the example of FIG. 22, the virtual machine 20-24 that the device 4 carries out does brightness sensor (2.01) 303e target of the processing (Yes of S54).

S56: When the virtual machine targets the same sensor as the processing object (Yes of S54) or when the virtual machine carries out the same processing (Yes of S55), the deployment order making module 123 carries out the judgment processing of the number of the connections of device 30. That is, the deployment order making module 123 judges whether or not the number of the connections of the relaying device 20 when deputing for the processing of sensor data of the sensor which is selected meets the simultaneous connection number of the relaying device 20.

When the connection number does not meet the number of the connections at the same time (No of S56), the deployment order making module 123 changes in the process S52, and detects a different device located in the next near place from the device 30 equipped with the sensor which is selected.

For example, it is exemplified that the number of the simultaneous connections of device 4 is “100” and the number of devices 30 in which the device 4 targeted for the processing is “85”. In addition, the number of devices 30 equipped with the brightness sensor (2.01) 303e where the device 1 targeted for the processing is “10”. When the virtual machine 20-24 of device 4 acts for the processing of the brightness sensor (2.01) 303e of the device 1, the number of the connections of the device 4 becomes “95” (=85+10) and a connection number at the same time is satisfied (Yes of S56).

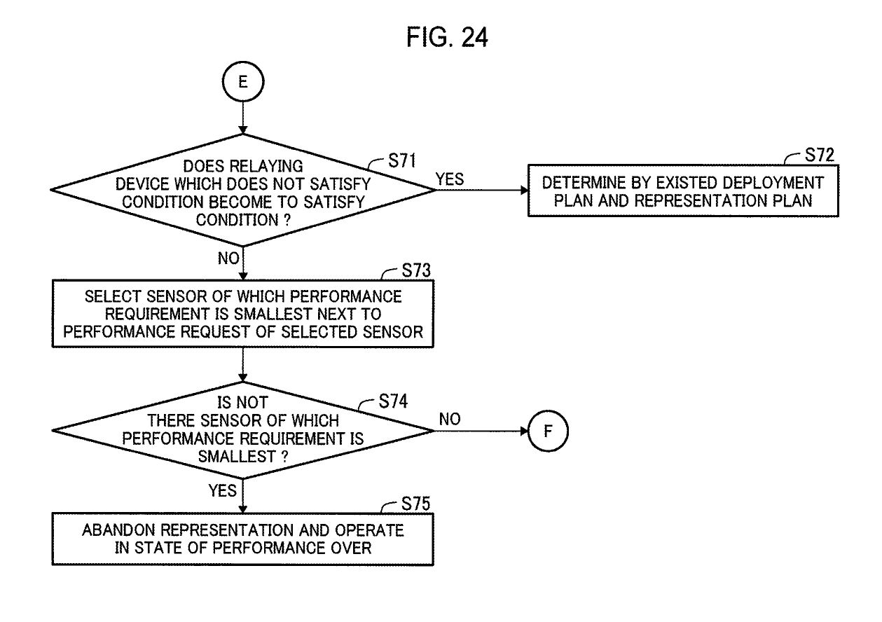

S57: When the connection number meets the number of the connections at the same time (Yes of S56), the deployment order making module 123 lets the virtual machine which is extracted act for the processing of sensor data of the sensor which is selected. In other words, the deployment order making module 123 lets the virtual machine 20-24 to work with the device 4 act for processing of the brightness sensor (2.01) 303e of which the device 1 targets as a processing object. In addition, the deployment order making module 123 deletes the brightness sensor (2.01) 303e from the deployment plan of the device 1. And processing of the deployment order making module 123 moves to the processing of flow chart diagram of FIG. 24 (E).

FIG. 23 is a diagram of second flow chart explaining a flow of the processing No. 2 of the deployment order making module 123 (S13 of FIG. 16, S44 of FIG. 20) depicted in FIG. 11. FIG. 23 illustrates processing ((D), Yes of S53 of FIG. 21) when the virtual machine (the relaying device 20) which act for the processing of sensor data is not found. For example, the processing changes in a flow chart of FIG. 23 when neither device does the brightness sensor (2.01) 303e as target for the processing and is not equipped with the applications 4-1, 8, 11.

S61: The deployment order making module 123, as same as the process S52 of FIG. 21, detects the device in which the distance near form the device 30 equipped with the sensor which is selected sequentially. And the deployment order making module 123 acquires the resource of each device with reference to the relaying device information list 113 (referring to FIG. 10). The deployment order making module 123 acquires a resource of the device 2.

S62: The deployment order making module 123 judges whether or not deploy the application to process the sensor data of the sensor which is selected, at the device which is detected. In other words, the deployment order making module 123 judges whether or not the device which is detected has the space resource which is able to deploy the application to carry out the processing of the sensor which is selected.

According to the relaying device information list 113 (FIG. 10), the performance index of the CPU of the device 2 is value “6”, and the memory capacity is value “4 GB”. In addition, for example, as for the performance index of the CPU of which the deployment planned application to device 2 based on the deployment plan uses is value “5.5”, and the memory capacity of that is value “3.3 GB”. As described in FIG. 22, when the device 2 targets the brightness sensor (2.01) 303e for the processing object, the device 2 is newly equipped with the applications 4-1, 11. According to the application information list 112 (referring to FIG. 9), the total of the performance index of the CPU, of which the applications 4-1, 11 use, is value “1.5”, and the total of the memory capacity is value “1.1 GB”. Therefore, the device 2 does not have a resource necessary for deployment of the brightness sensor (2.01) 303e (No of S62).

When it is not possible to deploy it (No of S62), the deployment order making module 123 changes to the process S61 and acquires a resource of device 3 located in the near place next. As for device 3, the performance index of the CPU is value “8”, and the memory capacity is value “4.0 GB”. In addition, for example, the performance index of the CPU that deployment planned application to the device 3 uses based on the deployment plan is value “6.5”, the memory capacity of that is value “2.7 GB”. Therefore, the device 3 has a resource necessary for the deployment of the applications 4-1, 11 (Yes of S62).

S63: When it is possible to deploy it (Yes of S62), the deployment order making module 123 detects the application to add and deploy in order to process the sensor data of the sensor which is selected. For example, the deployment order making module 123 detects the applications 4-1, 11 to add and deploy to the device 3.

S64: The deployment order making module 123 judges whether or not the processes S62, S63 are completed for all the devices.

In this embodiment, the deployment order making module 123 acquires a resource (the performance index of the CPU is “10” and the memory capacity is “6.0 GB”) of the device 4 more. For example, the performance index of the CPU, of which the deployment planned application to the device 4 uses based on the deployment plan, is value “5” and the memory capacity is value “2.2 GB”. When the device 4 targets the brightness sensor (2.01) for a processing object, the device 4 may be equipped with the application 4-1 (the performance index of the CPU is “1” and the memory capacity is “1 GB”) newly. Therefore, the device 4 has a resource necessary for deployment of the application 4-1 (Yes of S62).

S65: When the processing of the processes S62 and S63 complete for all devices (Yes of S64), the deployment order making module 123 judges whether or not the device which act for the processing of the sensor data of the sensor which is selected is detected.

S66: When detecting the device (Yes of S65), the deployment order making module 123 adds and deploys the application, which carries out the processing the sensor which is selected, to a device acting for the processing.

In addition, when detect the plurality of devices which are deployed, the deployment order making module 123 selects the device of which the number of applications to additionally deploy is fewer. Therefore, the deployment order making module 123 selects the device 4 that there is less number of application to deploy among the device 3 and the device 4. In this way, it is possible to hold down the total number of applications to deploy to the relaying device 20. And the deployment order making module 123 deletes the applications 4-1, 11 from the deployment plan of the device 1 and adds the application 4-1 to the deployment plan of the device 4.

The deployment order making module 123 changes for the processing of the flow chart in FIG. 24 after one of process S65 or S66 (E).

FIG. 24 is a diagram of third flow chart explaining a flow of processing No. 2 of the deployment order making module 123 depicted in FIG. 11 (S13 of FIG. 16, S44 of FIG. 20).

S71: The deployment order making module 123 determines whether or not it became to meet the condition of the performance of relaying device 20 or the condition of the number of the simultaneous connections by representation with other relaying device 20.

S72: When meeting the condition (Yes of S71), the deployment order making module 123 outputs the deployment plan and the representation plan with other relaying device 20.

S73: On the other hand, when not meeting the condition (No of S71), the deployment order making module 123, as similar to the process S51 of FIG. 21, selects the sensor in which the performance requirement is next small.

S74: The deployment order making module 123 determines whether or not the sensor that performance requirement is next small exists.

S75: When the sensor that performance requirement is next small does not exist (Yes of S74), the deployment order making module 123 finishes the processing No. 2. Even if the deployment plan is in condition not to meet the condition of the performance of relaying device 20 or the condition of the number of the simultaneous connections, the deployment order making module 123 orders deployment according to the deployment plan.

On the other hand, when the sensor exists (No of S74), the deployment order making module 123 changes to the process S52 of FIG. 21 and detects the relaying device 20 which acts for the processing of the sensor which is newly selected.

In this way, the deployment order making module 123 according to the present embodiment detects the relaying device 20 which is available for representation without adding the application. And when there is not relaying device 20 which is available for representation without adding the application, the deployment order making module 123 detects the relaying device 20 having the resource which is able to additionally deploy the application. Therefore, it is possible that the deployment order making module 123 selects the relaying device 20 acting for the processing of sensor so as to use a resource of relaying device 20 effectively.

[Flow of Processing No. 3]

Then, according to FIG. 25, a flow of processing No. 3 of the deployment order making module 123 (S16 of FIG. 16) depicted in FIG. 16 will be described in detail.

FIG. 25 is a diagram of flow chart explaining a flow of processing No. 3 of the deployment order making module 123 (S16 of FIG. 16) depicted in FIG. 11.

S81: When the deployment order making module 123 detects movement of the device 30, the deployment order making module 123 extracts a device located in an appointed distance range from the device 30 concerned. In addition, the sensor application information management module 121 updates the sensor information list 111 (referring to FIG. 8), and the application information list 112 (referring to FIG. 9).

For example, when the device 30 equipped with an oxygen concentration sensor newly moves, the sensor application information management module 121 adds the information of the oxygen concentration sensor to the sensor information list 111. In addition, the sensor application information management module 121 adds information of the application which carries out the processing prescribed depending on the oxygen concentration sensor to the application information list 112.

On the other hand, it is exemplified that the device 30 equipped with the humidity sensor (2.1) moves and became absent. When the device 30 equipped with the humidity sensor (2.1) does not exist elsewhere, the sensor application information management module 121 deletes the information of the humidity sensor (2.1) from the sensor information list 111. In addition, the sensor application information management module 121 deletes the information of the related application to only the humidity sensor (2.1) from the application information list 112. In more details, the sensor application information management module 121 deletes the information of application 2.

S82: The deployment order making module 123 selects the relaying device 20 of the sensor, which moved device 30 is equipped with, among a plurality of relaying devices 20 which are extracted. In addition, the deployment order making module 123 selects the relaying device 20 that the number of the processing, which is included in a plurality of the processing prescribed depending on a sensor of device 30 which moved and which is not included in a set of a plurality of the processing of sensors that the relaying device 20 targets, is less.

It is exemplified that the device 30 equipped with the brightness sensor (1.1) 303f moved, as mentioned above in FIG. 5. The first, second relaying devices 20-11, 20-12 depicted in FIG. 5 corresponds to the first, the second virtual machines to deploy to the device 1, and a third relaying device 20-13 depicted in FIG. 5 corresponds to the virtual machine 20-24 of the device 4. The deployment order making module 123 selects the relaying device 20 of the brightness sensor (1.1) 303f among the first and second virtual machines.

According to the example of FIG. 5, the deployment order making module 123 calculates the number of the processing, that is “2”, which is not included in the application 1-2, 8 and 9 that the first virtual machine targets for processing of the sensor, among the applications 4, 8, 11. In addition, the deployment order making module 123 calculates the number of the processing, that is “1”, which is not included in the applications 2, 5, 8, 9 and 11 that the second virtual machine targets for processing of sensor, among the applications 4, 8, 11. And the deployment order making module 123 compares number “2” of the processing not to be included in the processing set of the first virtual machine with the number “1” not to be included in the processing set of the second virtual machines and selects the second virtual machine that there are fewer numbers as relaying device 20.

Thereby, it is possible that the deployment order making module 123 selects the relaying device 20 of the sensor equipped with the device 30 which moved so that the total number of applications of relaying device 20 becomes minimum. Therefore, it is possible that the deployment order making module 123 selects the relaying device 20 of device 30 which moved so as to use a resource of relaying device 20 effectively.

S83: The deployment order making module 123 judges whether or not the relaying device 20 which processes the sensor equipped with the device 30 which moved meets the condition of the performance. The deployment order making module 123 judges whether or not the total of the resource that the application of the relaying device 20 which is selected uses is settled within the resource of the device.

S84: When meeting the condition of the performance (Yes of S83), the deployment order making module 123 judges whether or not the relaying device 20 which processes the sensor equipped with the device 30 which moved meets the condition of the connection number at the same time.

S85: When not meeting either condition (No of S83, No of S84), the deployment order making module 123 carries the processing No. 2 explained in FIG. 21-FIG. 24.

S86: When meeting both conditions (Yes of S84), the deployment order making module 123 deletes the information of the application which relates only to the sensor concerned from the relaying device 20 which processed the sensor equipped with the device 30 which moved.

For example, according to the example of FIG. 5, when the virtual machine 20-24 of the device 4 does not collect the sensor data of the brightness sensor (1.1) 303f from other device 30, the deployment order making module 123 deletes the application 4 from the virtual machine 20-24. In addition, when the virtual machine 20-24 collects the sensor data of the brightness sensor (1.1) 303f from other device 30, the deployment order making module 123 does not delete the application 4. In addition, the relaying device information management module 122 deletes the information of brightness sensor (1.1) 303f from information of device 4 and adds the information of brightness sensor (1.1) 303f to the information of the device 1, in the relaying device information list 113 (referring to FIG. 10).

### Other Embodiment

In addition, the embodiment mentioned above exemplified a case to realize the relaying device 20 according to the virtual machine. But when the relaying device 20 is realized with a physical machine, as similar to a case of the virtual machine, it is possible to select the relaying device 20 of each sensor so as to use a resource of relaying device 20 effectively.

In addition, the deployment order making module 123 may select the relaying device 20 located in the place, where device 30 equipped with a sensor is not able to communicate, as relaying device 20 acting for the processing of the sensor in the processing No. 2. In this case, the selected relaying device 20, for example, receives the sensor data via another relaying device 20 or the center server 10 and carries out the processing. Thereby, it is possible to reduce the total number of application which deploy to the relaying device 20 more and to use a resource of relaying device 20 effectively.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A selection method of a relaying device comprising:
collecting, by a processing unit, sensor data which a sensor in a device detects from one or a plurality of the device; and
selecting, by the processing unit, when changing relaying device which process a certain sensor from one relaying device to another relaying device among a plurality of the relaying devices which carries out the one or more processing prescribed depending on the sensor and outputs a result of the processing in each, a relaying device that a number of processing, which is not included in a set of a plurality of the processing of sensors that the relaying device targets among a plurality of the processing prescribed depending on the certain sensor, is less, as a candidate of another relaying device.

2. A selection method of a relaying device comprising:
collecting, by a processing unit, sensor data which a sensor in a device detects from one or a plurality of the device; and
selecting, by the processing unit, when selecting the relaying device which carries out the processing of the sensor among a plurality of the relaying devices which carries out the one or more processing prescribed depending on the sensor and outputs a result of the processing, the relaying device that total number of the processing prescribed depending on the sensor that the relaying device targets in the plurality of relaying devices, is less, as a candidate of the relaying device.

3. The selection method according to claim 1, wherein the selecting comprises selecting the relaying device, that the number of the processing, of which the relaying device carries out in parallel, does not exceed a predetermined value prescribed depending on the processing, as the candidate.

4. The selection method according to claim 3, wherein the selecting comprises:
calculating a number of deployment of the processing of the relaying device, that the number of the processing, of which the relaying device which is constituted according to a virtual machine carries out in parallel, does not exceed the predetermined value prescribed depending on the processing; and
selecting the relaying device from the relaying device, which is calculated the number of deployments, as the candidate of the relaying device.

5. The selection method according to claim 1, wherein the selecting further comprises second selecting, when the candidate of the relaying device does not meet either or both of a condition of a performance of the relaying device and a condition of a number of connections to the device, the relaying device which acts for the processing of a part of the sensor of which the candidate of the relaying device targets for the processing.

6. The selection method of the relaying device according to claim 5, wherein the second selecting comprises selecting the relaying device, which targets to same sensor as the part of the sensor of which the candidate of the relaying device targets for the processing, as the relaying device which acts for the processing of the part of the sensor.

7. The selection method of the relaying device according to claim 5, wherein the second selecting comprises selecting the relaying device, which carries out same processing as the processing of which the candidate of the relaying device targets for the processing, as the relaying device which acts for the processing of the part of the sensor.

8. The selection method of the relaying device according to claim 1, wherein the selecting comprises:
comparing the number of the processing, which is not included in a first set of the plurality of the processing of sensors that first relaying device targets among the plurality of the processing prescribed depending on the certain sensor, with the number of the processing, which is not included in a second set of the plurality of the processing of sensors that second relaying device targets among the plurality of the processing prescribed depending on the certain sensor;
selecting the candidate of relaying device of which the number of the processing is less among the first and second relaying devices.

9. The selection method of the relaying device according to claim 2, wherein the selecting comprises:
comparing a total number of the processing prescribed depending on the sensor, of which first and second relaying devices targets for the processing, based on a first combination of the first and second relaying devices with a total number of the processing prescribed depending on the sensor, of which the first and second relaying devices targets for the processing, based on a second combination of the first and second relaying devices; and
selecting the candidate of relaying device of which the total number of the processing is less among the first and second relaying devices.

10. A non-transitory computer readable storage medium storing therein a program for causing a computer to execute a process, the process comprising:
collecting, sensor data which a sensor in a device detects from one or a plurality of the device; and
selecting, when changing relaying device which process a certain sensor from one relaying device to another relaying device among a plurality of the relaying devices which carries out the one or more processing prescribed depending on the sensor and outputs a result of the processing in each, a relaying device that a number of processing, which is not included in a set of a plurality of the processing of sensors that the relaying device targets among a plurality of the processing prescribed depending on the certain sensor, is less, as a candidate of another relaying device.

11. A non-transitory computer readable storage medium storing therein a program for causing a computer to execute a process, the process comprising:
collecting, sensor data which a sensor in a device detects from one or a plurality of the device; and
selecting, when selecting the relaying device which carries out the processing of the sensor among a plurality of the relaying devices which carries out the one or more processing prescribed depending on the sensor and outputs a result of the processing, the relaying device that total number of the processing prescribed depending on the sensor that the relaying device targets in the plurality of relaying devices, is less, as a candidate of the relaying device.

12. The storage medium according to claim 10, wherein the selecting comprises selecting the relaying device, that the number of the processing, of which the relaying device carries out in parallel, does not exceed a predetermined value prescribed depending on the processing, as the candidate.

13. The storage medium according to claim 12, wherein the selecting comprises:
calculating a number of deployment of the processing of the relaying device, that the number of the processing, of which the relaying device which is constituted according to a virtual machine carries out in parallel, does not exceed the predetermined value prescribed depending on the processing; and
selecting the relaying device from the relaying device, which is calculated the number of deployments, as the candidate of the relaying device.

14. The storage medium according to claim 10, wherein the selecting further comprises second selecting, when the candidate of the relaying device does not meet either or both of a condition of a performance of the relaying device and a condition of a number of connections to the device, the relaying device which acts for the processing of a part of the sensor of which the candidate of the relaying device targets for the processing.

15. The storage medium according to claim 14, wherein the second selecting comprises selecting the relaying device, which targets to same sensor as the part of the sensor of which the candidate of the relaying device targets for the processing, as the relaying device which acts for the processing of the part of the sensor.

16. The storage medium according to claim 14, wherein the second selecting comprises selecting the relaying device, which carries out same processing as the processing of which the candidate of the relaying device targets for the processing, as the relaying device which acts for the processing of the part of the sensor.
